(19) United States
(12) Patent Application Publication
(10) Pub. No.: US 2012/0200453 A1
(43) Pub. Date: Aug. 9, 2012

(54) Method and Device for Supplying a Reflection Signal

(76) Inventor: Thomas Brosche, Gerlingen (DE)

(21) Appl. No.: 13/393,513

(22) PCT Filed: Aug. 6, 2010
(86) PCT No.: PCT/EP10/61489

§ 371 Date: Apr. 11, 2012

(30) Foreign Application Priority Data
Sep. 1, 2009 (DE) 10 2009 027 051.6

(51) Int. Cl. G01S 7/285

(52) U.S. Cl. 342/175

(57) ABSTRACT

The disclosure relates to a method and a device for supplying a reflection signal. According to the disclosure, an intermediate frequency signal having a high intermediate frequency can be demodulated in a numerical manner into I/Q components without intermediate frequency by means of a two channel sampling, thus enabling a complex reflection factor to be obtained.

### FIELD OF THE INVENTION

The present invention relates to a method for provision of a reflection signal and to an apparatus for provision of a reflection signal.

### PRIOR ART

The book by Skolnik, M. I., “Introduction to Radar Systems”, McGraw-Hill Book Company, Inc., New York, 1962 provides an introduction to radar systems.

The book by Ludloff, A., “Praxiswissen Radar and Radarsignalverarbeitung” [The practical knowledge of radar and radar signal processing], 2^{nd} Edition, Vieweg, Wiesbaden, 1998 describes principles of radar technology.

The document DE 20 2007 009 431 U1 describes a wideband reception system.

The paper by Sliskovic, M., “Software Defined Automotive Receiver for Broadcasting Services”, Digits of Technical Papers, International Conference on Consumer Electronics 2008, pages 1-2, Las Vegas, 9-13 Jan. 2008 describes software automobile receivers.

The document by Bonek, E. et al., “Personal Communications Transceiver Architectures for Monolithic Integration”, 5th IEEE International Symposium on Personal, Indoor and Mobile Communications, Volume 1, pages 363-368, 1994, relates to transceiver architectures for personal communication.

The document by Kato, Y., et al., “IQ Imbalance Compensation Scheme for MBOFDM with Transmit Diversity”, The 2006 IEEE International Conference on Ultrawideband, pages 293-298, 24-27 Sep. 2006, describes compensation for IQ imbalances.

The document by Lee, Kang-Yoon et al., “Full-CMOS 2-GHz WCDMA (Wideband Code Division Multiple Access) Direct Conversion Transmitter and Receiver”, IEEE Journal of Solid-State Circuits, Volume 38, Issue 1, pages 43-53, January 2003, describes a transmitter and a transmitter and receiver for direct conversion of WCDMA.

The document by Sachs, S. et al., “M-Sequence Ultra-Wideband-Radar: State of Development and Applications”, Radar Conference 2003, Adelaide (Australia), 3-5 Sep. 2003 deals with an ultra-wideband radar.

The document by Norsworthy, S. et al., “Delta Sigma Data Converters, Theory Design and Simulation”, IEEE Press, New York, 1996, ISBN 0-7803-1045-4, discloses delta-sigma data converters.

Shoaei, O., “Continuous-time Delta-Sigma A/D (Analog/Digital) Converters for High Speed Applications”, Dissertation Carleton University 1995, deals with delta-sigma analog/digital conversion.

The document by Cherry, J. A., Snelgrove, W. M., “Continuous-time Delta-Sigma Modulators for High Speed A/D Conversion”, Kluwer Academic Publishers, Boston, 2000, describes delta-sigma modulators for rapid analog/digital conversion.

The book by Michael Hiebel, “Grundlagen der vektoriellen Netzwerkanalyse, Rohde&Schwarz” [Principles of vectorial network analysis, Rohde&Schwarz] describes the principle of reflection and transmission factor measurement.

The book by Behzad Razavi, “RF Microelectronics, Prentice Hall” describes various transceiver architectures.

Radar measurement systems which are based on the transmission of a signal and the measurement of a signal reflected by a body can be used for material analysis with the aid of electromagnetic waves. Since the transmitted signals are subject to many different types of disturbances on their path to the measurement object and back from the measurement object, for example fading or frequency cancellation, and since, furthermore, disturbance reflections can also occur, it is an aim to obtain received signals which differ as clearly as possible from the disturbance signals or noise signals. Because of the wave characteristic of radar signals, mutual cancellation of peaks and troughs in the electromagnetic wave can occur if the reflection signals are superimposed in a disadvantageous manner.

One aim in radar measurement technology is therefore to superimpose received signals as coherently as possible. Coherent superimposition of signals received at different times in succession leads to uniform amplification and assists in making the signal better identifiable.

### DISCLOSURE OF THE INVENTION

One object of the present invention is to specify an effective provision of reflection signals.

According to one exemplary embodiment of the invention, a method is provided for provision of a reflection signal or of a reflection parameter, and an apparatus for provision of a reflection signal, according to the independent patent claims.

Further exemplary embodiments and developments of the method according to the invention and of the apparatus according to the invention can be found in the dependent patent claims.

According to one exemplary embodiment of the present invention, a method is provided for provision of a reflection signal. The method comprises the reception of a received signal which has been converted to an intermediate frequency, that is to say which has been preprocessed, at an input, referred to for short here as the intermediate-frequency signal or intermediate-frequency received signal. The intermediate-frequency signal is received at an input of a splitting device, that is to say it is provided by a preceding analog stage in the receiver (antenna, filter, amplifier, mixer). The intermediate-frequency signal has a narrow bandwidth in comparison to the intermediate frequency. The transmitted signal and the received signal, which, for example, may correspond to a continuous ramp, may have a wideband width, or may be an ultra-wideband signal (UWB signal).

Furthermore, an intermediate-frequency reference signal is provided or received at an input of a first and second sampling device, which is likewise at the intermediate frequency. The intermediate-frequency reference signal is provided or received at in each case one input of the digital signal preprocessing, in the same way as the intermediate-frequency received signal, and can be used as a sampling clock for an analog/digital converter contained in the digital signal preprocessing. In this case, the reference signal may be provided or received by an internal device for generation of the intermediate-frequency reference signal. The internal device may generate and provide the intermediate-frequency reference signal.

After the reception of the intermediate-frequency signal, the intermediate-frequency signal is split into a first channel and a second channel. The splitting device may be used for this purpose. Splitting into at least two channels provides a first channel signal and a second channel signal in the respective channel. The channel signals may be copies of the intermediate-frequency signal.

The first channel signal is sampled with a first clock signal, and the second channel signal is sampled with a second clock signal, wherein the second clock signal is shifted in phase with respect to the first clock signal. The phase shift may be a time shift. In one example, the phase shift may be plus 90 degrees or, in another example, minus 90 degrees. In other words, this means that the phase shift may be ±90 degrees. Both the first clock signal and the second clock signal may be derived from the intermediate-frequency reference signal. In one example, the intermediate-frequency reference signal may be generated by mixing of a first output signal from a first signal generator or a first frequency generator and a second output signal from a second signal generator. In particular, the first clock signal and the second clock signal may be substantially at the exact intermediate frequency, that is to say substantially the exact difference frequency between two signal generators or two frequency generators. These frequency generators may generate a transmitted signal or a first reference signal. The received signal may be obtained from the transmitted signal and, in particular, the intermediate-frequency received signal may be obtained from the received signal and the first reference signal.

The two sampled channel signals are matched to the clock of the sampled first channel signal by synchronization of the sampled second channel signal. In this case, the matching may relate to a time profile. This allows the phase shift introduced for sampling to be reversed again. By way of example, a zero-order hold (ZOH) element may be used to synchronize the channel signals.

The sampled signals have a clock which can be predetermined by the sampling rate. The clock or the clock rate of the sampled first channel signal and of the sampled second channel signal may be reduced by means of a decimation device. For example, the clock-reduced first channel signal may be provided at a first output, and the clock-reduced second channel signal may be provided at a second output. This means that the method provides for internal processing to be carried out at a high clock rate, as a result of which when using a suitable sigma-delta modulator for digitizing or quantization, quantization errors, digitizing noise or quantization noise can be displaced to a frequency range in which the disturbances do not significantly disturb the channel signal, and can easily be filtered (noise shaping). The reduction of the clock rate at the outputs allows the generated signal to be further processed using simple hardware, which is not subject to any major stringent requirements, because of the low clock rate.

The decimation device may be formed from two or more stages.

The clocks can be synchronized between the second channel signal and the first channel signal by means of a zero-order hold element and/or by means of an image-frequency filter. The respectively used image-frequency filter may be selected as a function of the clock shift of the first clock with respect to the second clock.

A sigma-delta modulator may be used for sampling, that is to say for conversion of an analog signal to a digital signal with a predeterminable clock. In one example, the sigma-delta modulator may also have a signal transfer function with low-pass characteristics and/or a noise transfer function with high-pass characteristics (noise shaping). The decimation function which is provided in a sigma-delta ADC may likewise have low-pass characteristics. In consequence, the sigma-delta ADC has a sigma-delta modulator and a decimation low-pass filter. A sigma-delta modulator (ΣΔ modulator or ΔΣ modulator) can quantize a signal with a word length of 1 bit or, for example, 3 bits. Because of this short word length, severe digitization noise may occur which, however, can be eliminated substantially by means of a low-pass filter (decimation filter), in particular in conjunction with a suitable noise transfer function in the modulator (noise shaping).

In order to suppress stabilization processes, a stabilization time of a signal generator can be waited for before the preprocessed signals are evaluated. It may be necessary to wait for the stabilization time since, when passing through the ramps of the modulation signal, the nominal value essentially cannot be assumed immediately after switching, but can be determined by oscillation about the nominal value, or is approximated only (aperiodically) to the nominal value. In order to allow the stabilization to be taken into account, a connection can be provided between a PLL and a decimation device.

In order to suppress the stabilization processes, the method can reduce the clock of the sampled first channel signal and/or the clock of the sampled second channel signal by means of in each case one first decimation device or by means of a first stage of a decimation device. In the subsequent stage, the method can wait for a stabilization time of a signal generator. After waiting for the stabilization time, a further reduction or decimation can be carried out in each case by means of a second decimation device or by means of a second decimation stage of the decimation device.

According to another exemplary embodiment of the present invention, an apparatus is described which is designed for provision of a reflection signal or of a reflection parameter. The apparatus has a splitting device, a first sampling device, a second sampling device, a synchronization device, a first provision device, a second provision device and a decimation device.

The splitting device may be designed for provision or reception of an intermediate-frequency signal at an input, in particular of an intermediate-frequency received signal, and for splitting the intermediate-frequency signal into a first channel and a second channel. The splitting device in consequence allows a first channel signal to be provided in the first channel, and a second channel signal to be provided in the second channel. The splitting device may be in the form of a Y-element, by which means substantially the same channel signals can be made available in both channels, immediately downstream from the splitting device. In another example, the same signal, that is to say the intermediate-frequency received signal, is sampled with two different sampling clocks and modulators, in order to obtain the functionality of a Y-element.

A sampling device is located in the respective channel downstream from the splitting device in the signal propagation direction. The sampling device may be designed for reception of an intermediate-frequency reference signal, for example by providing an input for the intermediate-frequency reference signal on the sampling device. The sampling device may have a first sampling device and a second sampling device, each for one channel. In this case, the first sampling device is adapted for sampling the first channel signal with a first clock signal, and the second sampling device is adapted in order to sample the second channel signal with a second clock signal. The second clock signal may be shifted in phase with respect to the first clock signal.

In other words, the first sampling device may be designed for sampling the channel signal with a first clock signal at substantially the exact intermediate frequency, determined by mixing of two PLL output signals. Furthermore, the second sampling device may be designed for sampling the second channel signal with a second clock signal at the exact intermediate frequency, determined by mixing of the two PLL output signals, and with a phase difference of either +90° or −90° with respect to the first clock signal.

A synchronization device, for example in one of the two channels, is designed for synchronization of the sampled second channel signal with the clock of the sampled first channel signal. The synchronization device may be an image-frequency filter, which may be designed for synchronization of the clock of the sampled second channel signal with the clock of the sampled first channel signal, and for filtering of undesirable signal components. One undesirable signal may be the image frequency.

Two equally clocked signals in the two channels can therefore be passed on to a decimation device.

The decimation device may be adapted to reduce the clock of the sampled first channel signal and the clock of the sampled second channel signal and, for example, to provide a first clock-reduced channel signal at a first connection, and a second clock-reduced channel signal at a second connection.

These two reduced-clock channel signals or I (In-phase) and Q (Quadrature) signals can be made available to a further apparatus for further processing.

The described method and/or the described apparatus allow/allows a radar system to be implemented with direct sampling of a received signal at an intermediate frequency, or of an intermediate-frequency received signal. In this case, complex sampling, a low-pass filter and decimation may be provided. The complex sampling may be carried out by means of pulse combs, which are shifted in time with respect to one another.

Furthermore, a two-stage decimation filter may be used. In this case, a first partial filter has an additional FIR filter added to it after the first decimation. By way of example, a classical partial filter may have an additional FIR filter added to it downstream from the first decimation in a signal propagation direction. For example, the first stage may be a conventional decimation filter or CIC filter of order K₀, and may have a decimation device with a decimation factor OSR, to which an additional FIR₂ filter may be added. The CIC decimation filter of order K₀ with the decimation device may be referred to as a sinc^{K0} filter. Another notation for a sinc^{K0} filter may be ((sin (x)/x)^{K0}.

In other words, an additional FIR filter (FIR₂) may be arranged between two conventional decimation filters and/or between two sinc filters.

The second stage may be a conventional decimation filter of order K₁, and may have a decimation device with a decimation factor N.

The complex sampling may be carried out by means of two sigma-delta modulators which can operate substantially exactly at the intermediate frequency in the I channel and with a sampling clock which is shifted in time through either −¼ of a clock cycle or +¼ of a clock cycle with respect to the sampling clock of the I channel. The sample signals which have been shifted in this way may form a pulse comb.

Furthermore, a plurality of variants of an image-frequency filter may be used. An image-frequency filter may have a hold element (for example a ZOH Zero Order Hold element).

According to another exemplary embodiment of the present invention, a computer-readable data storage medium is specified, on which a program code is stored which, when it is run by a processor, carries out the method according to the invention for provision of a reflection signal.

By way of example, an FPGA (Field Programmable Gate Array) may also be provided, in which case a chargeable control sequence of the FPGA may be regarded as software. The FPGA may be programmed such that, when the FPGA receives appropriate input signals, the FPGA carries out the method according to the invention for provision of a reflection signal. The program or the structure of the FPGA may also be stored in an EPROM (Erasable Programmable Read-Only Memory). It is also possible to use an ASIC (application-specific integrated circuit) rather than an FPGA.

It should be noted that various aspects of the invention have been described with reference to different subjects. In particular, some aspects have been described with reference to apparatus claims while, in contrast, other aspects have been described with reference to method claims. However, a person skilled in the art can see from the above description and from the following description that, except where described otherwise, in addition to every combination of features which belongs to a category of subjects, any combination between features which relates to different categories of subjects may be regarded as being disclosed by this text. In particular, combinations between features of apparatus claims and features of method claims are intended to be disclosed.

### BRIEF DESCRIPTION OF THE FIGURES

Further exemplary embodiments of the present invention will be described in the following text with reference to the figures.

FIG. 1 shows an outline block diagram of a UWB measurement system according to one exemplary embodiment of the present invention.

FIG. 1a shows a block diagram of a measurement arrangement as a multi-port measurement arrangement according to one exemplary embodiment of the present invention.

FIG. 2a shows a block diagram of a single-heterodyne UWB radar system according to one exemplary embodiment of the present invention.

FIG. 2b shows a block diagram of a first frequency generator according to one exemplary embodiment of the present invention.

FIG. 2c shows a block diagram of a second frequency generator according to one exemplary embodiment of the present invention.

FIG. 3 shows a time/frequency graph of a stepped ramp according to one exemplary embodiment of the present invention.

FIG. 4a shows a block diagram of a double-heterodyne UWB radar system according to one exemplary embodiment of the present invention.

FIG. 4b shows a block diagram of a single-sideband mixer according to one exemplary embodiment of the present invention.

FIG. 4c shows block diagrams of a conventional decimation filter with a downstream additional FIR filter according to one exemplary embodiment of the present invention.

FIG. 5 shows a block diagram of a single-heterodyne UWB radar system with direct sampling according to one exemplary embodiment of the present invention.

FIG. 6 shows a graph of pulse combs in order to describe the complex sampling according to one exemplary embodiment of the present invention.

FIG. 7 shows a block diagram of I/Q demodulation according to one exemplary embodiment of the present invention.

FIG. 8 shows a block diagram of a structure for digital signal processing with complex sampling, low-pass filtering and decimation according to one exemplary embodiment of the present invention.

The illustrations in the figures are schematic and not to scale. In the following description of the figures, the same reference numbers are used for the same or corresponding elements.

### DETAILED DESCRIPTION OF THE FIGURES

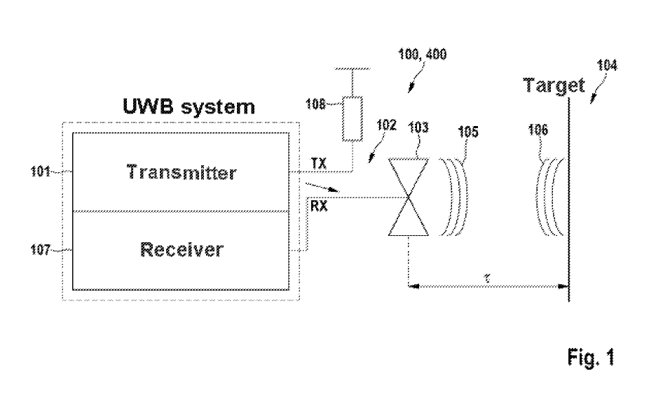

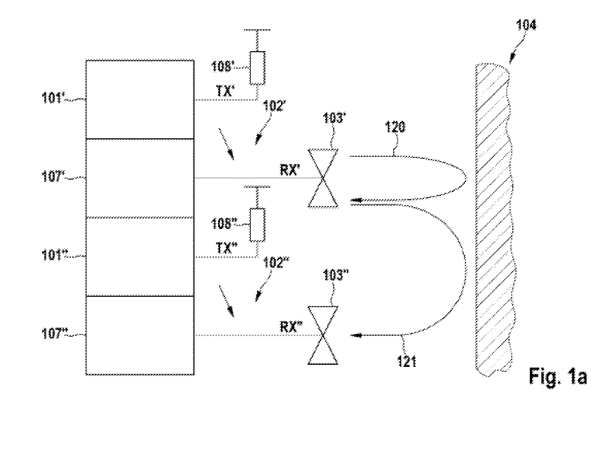

FIG. 1 shows the basic design of a UWB (Ultra Wide Band, Ultra-Wideband) measurement system. A UWB measurement system 100 such as this may be used for material analysis with the aid of electromagnetic waves, for example for identification of human tissue. A UWB measurement system is a radar measurement system with a generally very wide measurement bandwidth (UWB, Ultra Wide Band), which operates on the radar measurement principle.

The UWB measurement system has a transmitter 101, which inputs a transmitted signal, which is produced by the transmitter 101, to the antenna 103 via a directional coupler (represented by the arrow 102 in FIG. 1). The modulated radar signal (TX) produced in the transmitter is emitted via the transmitting antenna 103 in the direction of the target 104. The emitted signal is represented by the waves 105 in FIG. 1. The emitted electromagnetic signal 105, TX is then reflected on a target 104 which may be present in the detection field. The propagation time between the transmitter 101, 103 and the receiver is t. By way of example, a target such as this may also be a junction between different materials.

Essentially, the frequency response and in particular the phase of the transmitted signal 105 are changed by the reflection or by entering into different materials. This results in a characteristic profile of a reflection curve over the frequency of the transmitted signal, and this can be represented as magnitude and phase. The profile can also be represented in Cartesian form (I/Q values) or the Gaussian numerical level.

Particularly for monostatic operation, the termination 108 ensures that the transmitted signal TX, which is not input to the antenna 103, is terminated matched to the characteristic impedance.

As an alternative exemplary embodiment (not illustrated in FIG. 1), two separate antennas 103, a transmitting antenna and a receiving antenna, may be used (bistatic operation). The termination 108 is not required for bistatic operation. In other words, during bistatic operation, the termination 108 forms the transmitting antenna 108. There is no directional coupler 102 during bistatic operation.

In FIG. 1, the reflected signal is represented by the waves 106 running in the opposite direction to the transmitting direction 105, and running in the direction of the antenna 103. The reflected signal 106 can be received again via the antenna 103. The received signal RX can be passed to the receiver 107, where it can be processed further.

The result of the further processing in the receiver 107 may be a complex-value reflection or transmission factor or a complex-value S parameter. The complex-value reflection factor S₁₁ is obtained from the ratio of the received signal RX to the transmitted signal TX over the (modulation) frequency f_{mod} or f_{Mod}. The complex-value reflection factor plotted against the frequency f_{mod} indicates the profile of the scatter parameter of the radio field. The reflection factor can be represented as I/Q values, in order to simplify the illustration.

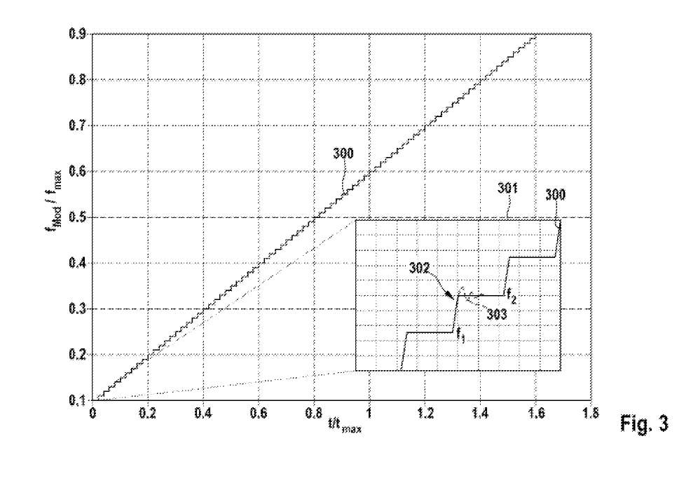

A stepped modulation signal may be used as the transmitted signal Tx, whose modulation frequency profile 300 is illustrated in FIG. 3. The enlargement 301 shows a detail of the profile of the modulation frequency. As can be seen from this enlargement, the steps of the stepped modulation 300 can run obliquely rather than at right angles, as a result of stabilization processes. Overshooting 303 can also occur as a result of stabilization processes at a change 302 from the frequency f1 to the frequency f2, that is to say between two different frequencies. Stabilization processes may occur when a change takes place between two frequencies f1, f2, that is to say at the staircase steps, since some time is required before internal PLLs (Phase Lock Loops) PLL1, PLL2 in the transmitter and/or receiver have stabilized at the different nominal frequency values. The frequency may be corrupted by stabilization processes, in particular initially.

FIG. 3 shows a normalized transmission frequency f_{Mod}/fₘₐₓ, that is to say the transmission frequency related to a maximum frequency. The figure also shows the normalized time t/tₘₐₓ, that is to say the time with respect to a maximum time or a period.

The frequency fₘₐₓ may vary in the Megahertz, Gigahertz or Terahertz range.

The received signal RX may be represented over the frequency, in particular over the modulation frequency, as the result or output of the UWB measurement system 100. By way of example, the result may be the profile of the scatter parameter S₁₁ of the radio field. A complex measured value S₁₁(f) can in consequence be determined for each modulation stage or for each selected transmission frequency.

The UWB measurement system 100 or the radar 100 admittedly operates with the stepped modulation 300 (step frequency modulation) in the frequency domain. However, a different modulation method could also be used instead of stepped modulation, for example the emission of a pulse or burst, FMCW (frequency-modulated continuous wave radar) or a pseudorandom sequence (PN) with an appropriately wide bandwidth.

FIG. 1 shows monostatic operation of the UWB system 100. During monostatic operation, only a single antenna 103 is used for both transmission and reception. A plurality of antennas may, however, also be operated in parallel (for example during bistatic operation).

That portion of the transmission power which is not emitted via the antenna 103 can be dissipated on the resistor 108.

The radar signal TX which is produced in the transmitter 101 and is modulated corresponding to the stepped modulation 300 is emitted via the transmitting antenna 103. The emitted electromagnetic signal is then possibly reflected on targets 104 present in the detector field, and is received again via the antenna 103. The received signal can be processed further in the receiver 107, and can be converted to complex-value reflection factors.

In the case of modulations which result in a received signal in the time domain, for example in the case of a pulse or pseudo-noise sequence a Fourier transformation may be carried out in the frequency domain in a downstream signal processing unit, in order to obtain the scatter parameters, as mentioned above, in the frequency domain.

In radar systems 100 which operate using so-called direct sampling, an attempt is made to reduce the analog circuit component of an evaluation circuit in a receiver 107. In other words, this means that an attempt is made as early as possible in the event of direct sampling in the receiver 107 to make use of digital circuit parts for signal processing, in particular for the provision of the scatter parameters of the radio field. Particularly in the case of UWB radar systems, this can lead to increased circuit complexity, since operation with wideband signals is also dependent on wideband amplifiers or wideband samplers. Wideband digital components such as wideband analog/digital converters (ADC) or wideband amplifiers involve increased complexity for production, however, and may be costly to purchase.

Ultra-wideband (UWB) radar systems can be used in many different applications. In addition to communication technology, UWB systems can also be used for target identification or target tracking. When an ultra-wideband (UWB) radar measurement system is in the form of an integrated circuit, attention should be paid to using as few multiplication units as possible for signal processing. Furthermore, when in the form of an integrated circuit, a high level of suppression of disturbance signals outside the useful band may be desirable. In this case, attention should also be paid to compensating for I/Q errors as well as possible.

UWB systems 100 may be in the form of homodyne systems with a single oscillator, or heterodyne systems with at least two oscillators PLL1, PLL2.

The basic idea of a radar measurement system for measurement of a frequency-dependent reflection factor in the frequency domain may be implemented using a double-oscillator embodiment PLL1, PLL2. The use of two radio-frequency oscillators PLL1, PLL2 makes it possible to produce an intermediate frequency in the receiver. The received signal is filtered and amplified at this intermediate frequency. This filtering and amplification makes it possible to achieve a high level of suppression of disturbance signals outside the receiver bandwidth and high sensitivity of the receiver 107 in that, inter alia, the 1/f noise, which can lead to disturbances in direct receivers, is substantially suppressed.

Working with an intermediate frequency essentially makes it possible to avoid a DC voltage offset leading to corruption of the received signal. A DC voltage offset can result from disturbance signals or from internal crosstalk in the receiving mixer. When working with the intermediate frequency, a bandpass signal, so to speak, is produced, which is not in baseband. In addition, IF (intermediate-frequency) filtering can also be carried out for disturbance suppression by the IF filter 204.

A circuit in a UWB system can be skillfully designed to ensure that the correlation characteristics of the phase noise remain between the transmitted signal TX or the received signal RX and the reference signal 221 used for demodulation, thus achieving high dynamics for the measurement system 100. For example, the reference signal 221 and the received signal RX may have the same signal components or the same frequency components f_{Mod}. Despite propagation on different paths, correlation characteristics can be maintained. In the double-oscillator embodiment, different oscillators are used for the transmitted signal TX and the reference signal 221, and are based on the same basic clock 208, 209.

These two oscillators may be in the form of PLLs (Phase Lock Loops). Both oscillators PLL1, PLL2 have phase noise. The PLLs may also be based on independent clock generators 208, 209 with an independent basic clock.

FIG. 1a shows a measurement arrangement for measurement having a four-port network (4-port network). This comprises two UWB systems 100 arranged in parallel. A first transmitted signal is emitted via the antenna 103′ and is also received via an antenna 103′ (monostatic operation). The antenna 103′ can therefore be regarded as a transmitting port and receiving port, that is to say as a two-port network.

This also applies in a similar manner to the antenna 103″. During bistatic operation, each port is associated with a separate antenna.

The transmitted signal TX′ propagates over the reflection path 120 and the scatter path 121. This means that the reflected transmitted signal TX′ is received both as a reflection received signal RX′ by the first UWB system 101′, 107′ and as a scattered received signal RX″ by the second UWB system 101″, 107″. Both received signals RX′, RX″ are further processed in a similar manner in both UWB systems 101′, 107′, 101″, 107″.

The signals from the second UWB system 101″, 107″ propagate in a corresponding manner.

The transmitters 101′, 101″ are synchronized with one another. The receivers 107′, 107″ are synchronized with one another. Alternatively and/or additionally, the transmitters 101′, 101″ are synchronized with the receivers 107′, 107″, that is to say they are based on the same clock signal or use the same signal source.

Any desired multiplicity N (N may be any desired natural number) of UWB systems may be connected in parallel, in order to produce a 2N port arrangement (for example N=2 is a 4-port arrangement). The N UWB systems may be integrated in a single appliance and their clock may be derived from a single clock f_{Q}. Furthermore, any desired number M (M may be any desired natural number) of transmitting or receiving channels may be added, in order to produce a 2N+M port arrangement.

The antennas 103′, 103″ of the 2N or 2N+M ports may have different polarization, thus allowing cross-polarization to be achieved. In the case of cross-polarization, the transmitted signal is sent, for example, with a first polarization and is received with a second polarization which differs therefrom (for example rotated through 90° with respect to one another). Systems having more than two ports can also be measured using a corresponding number of transmission channels and reception channels. A transmission channel may essentially correspond to a transmission port, and a reception channel may correspond to a reception port. FIG. 1a in the figure accordingly shows a system with two transmission/reception channels or 2 channels and 4 ports. In particular, FIG. 1a shows a system having a first transmission (TX′)/reception (RX′) channel or a first two-port network 103′ (first transmission/reception two-port network) and having a second transmission (TX “)/reception (RX”) channel or a second two-port network 103″ (transmission/reception two-port network). Furthermore, the first transmission port RX′ is associated with the first reception port RX′, and the first two-port network 103′ (reception port/second input), and the second transmission port TX″ is associated with the second reception port RX″ and the second two-port network 103″ (second transmission/reception two-port network). A channel 120 or a path 120 may have the first transmission channel and the associated reception channel. This may be an association in pairs.

In contrast to the association in pairs, any desired number (>=1) of transmission ports and any desired number (>=1) of reception ports may be provided, and each reception port can receive the signal from each transmission port.

A channel 121 or path 121 may have the first transmission channel and the second reception channel (for example in the case of cross-polarization).

All the transmitters and receivers in a system are synchronized with one another, and are preferably based on the same clock f_{Q}.

The parallel arrangement of UWB systems 100 allows an embodiment as a multi-channel measurement system and measurement by means of a multiplicity of transmission/reception channels or channels, with the multiplicity being greater than 2 and corresponding to the number of systems 100 arranged in parallel. An associated method envisages the provision of a plurality of channels. An N channel measurement system envisages N UWB systems 100 arranged in parallel.

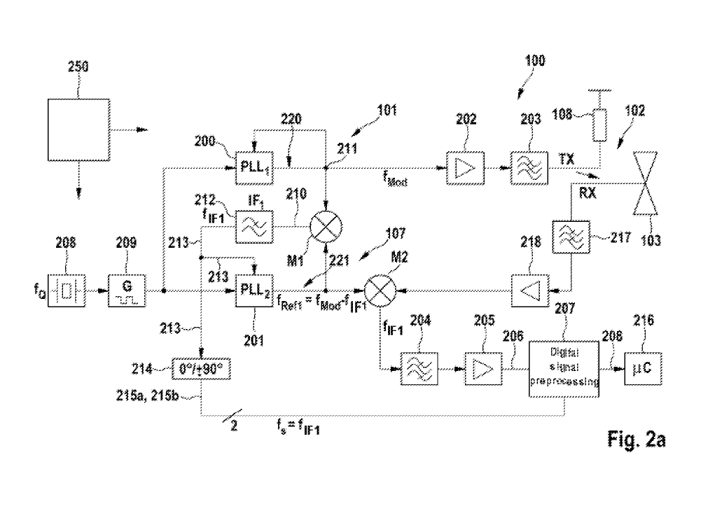

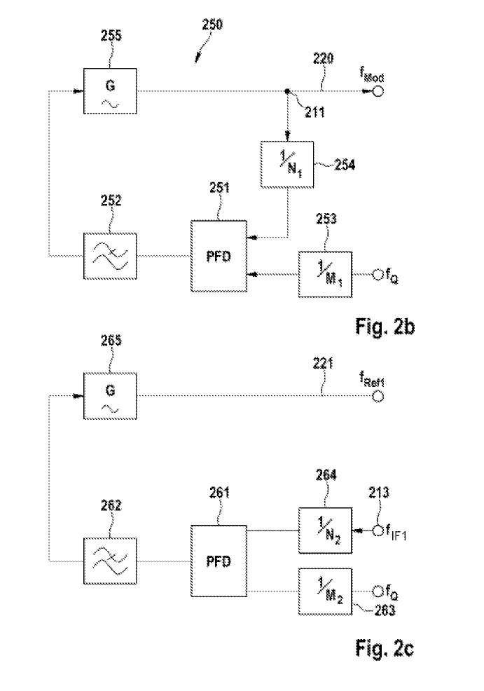

FIG. 2a shows a block diagram of a single-heterodyne UWB radar system. In particular, FIG. 2a shows an exemplary embodiment in which the useful information is recovered from a received intermediate-frequency signal 206 (which is present essentially unfiltered and unamplified at the output of the mixer M2) by sampling (direct sampling) with a sample signal 215a, 215b, with the sample signal 215a, 215b being at the same intermediate frequency f_{IF1} as the received intermediate-frequency signal 206. This arrangement makes it possible to eliminate phase errors from the oscillators PLL1, PLL2.

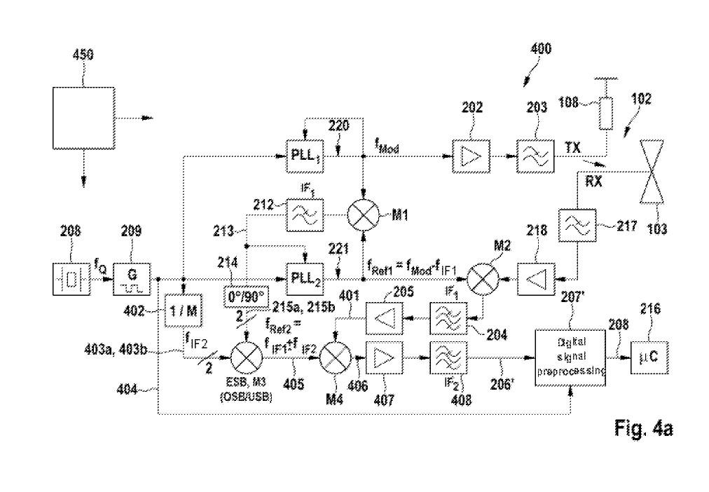

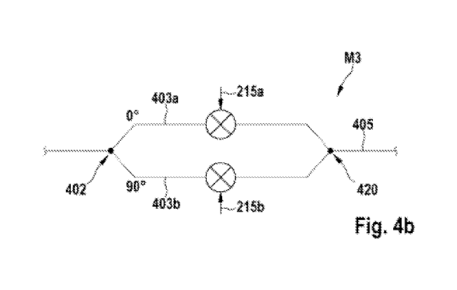

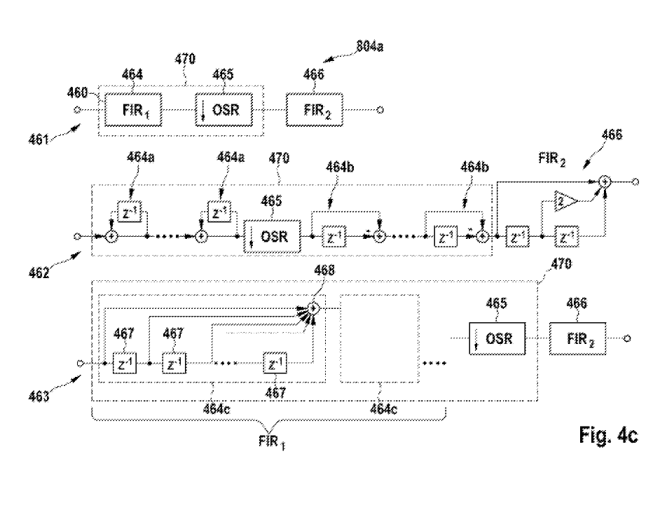

FIG. 4a shows one exemplary embodiment, in which a received intermediate-frequency signal 401 has a first intermediate frequency f_{Ref1} removed from it by mixing with a further signal 405, at a second reference frequency f_{Ref2}, with the further signal 405 containing the same intermediate frequency f_{IF1} as the received intermediate-frequency signal 401. Therefore, essentially, the signal obtained on mixing no longer contains the first intermediate frequency f_{IF1} and in consequence this arrangement also makes it possible to eliminate phase errors of the oscillators PLL1, PLL2.

In FIG. 2a, the first reference signal 221 is produced, inter alia, by mixing the two output signals 220, 221 from the PLLs PLL1, PLL2 or the frequency generators PLL1, PLL2. The generation of the transmitted signal TX and of the received signal RX from the output signal from the first PLL PLL1 and the use of the first reference signal for demodulation, and the specific way in which the sampling frequency fₛ of the sample signals 215a, 215b is produced in accordance with the exemplary embodiment in FIG. 2a means that different stabilization responses of the PLLs essentially do not lead to phase errors in the measurement signal. The specific way in which the sampling frequency fₛ is produced may mean that the sampling frequency is likewise at the first intermediate frequency f_{IF1}, in the same way as the received intermediate-frequency signal 206. In consequence, phase errors which are contained in the sample signal 215a, 215b and in the received intermediate-frequency signal 206 essentially in the same sense cancel one another out. FIG. 2a therefore shows an apparatus for direct sampling of a received intermediate-frequency signal 206.

Or, in other words, the first reference signal 221, f_{Ref1} may be produced by mixing the two output signals 220, 221 from the frequency modulators PLL1, PLL2. The mixer M1 produces a signal 213 at the difference frequency f_{IF1}=f_{Mod}−f_{Ref1}. The frequency of the signal results from filtering by means of the low-pass filter IF1, 212, from the frequencies f_{Mod}−f_{Ref1} and f_{Mod}+f_{Ref1} produced during mixing. The PLL2 receives this frequency f_{IF1} as an input 213, and regulates at this frequency. The reference frequency f_{Ref1}, 221 is therefore defined, as described in detail in FIG. 2c, by division by the factors M2, 263 and N2, 264.

The first reference signal 221 is at the same time used for mixing, in particular for down-mixing of the received signal RX to the intermediate frequency f_{IF1}. Furthermore, the signal 213 is passed to the splitting device 214, as a result of which the sample clock signals 215a, 215b are likewise at the intermediate frequency f_{IF1} and, as a result of which, in particular, the sampling clock fₛ used for sampling the intermediate-frequency signal 206, in particular the received intermediate-frequency signal 206, contains the intermediate frequency f_{IF1}.

In consequence, the phase noise of the oscillators PLL1 and PLL2 is contained uniformly both in the first reference signal 221 and in the sampling clock fₛ, as a result of which the phase noise is cancelled out on sampling. In particular at least a portion of the phase noise of the received signal RX is eliminated by the mixing, by mixer M2, of the received signal Rx with the first reference signal. The rest of the phase noise is eliminated essentially by the specific way in which sampling is carried out, as shown in FIG. 2a. As has already been described, the specific type of sampling takes account of the fact that the frequency of the received intermediate-frequency signal 206 essentially matches the sampling frequency fₛ.

The transmitted signal 220 or output signal 220 from the PLL₁ may have first phase noise from the first oscillator PLL₁. The first reference signal 221 or the output signal 221 from the PLL₂ has second phase noise, which is initially independent thereof.

The mixing of the transmitted signal 220, TX and the first reference signal 221 in the mixer M1 results in the mixer signal 210 which, downstream from the low-pass filter IF1, 212, becomes the intermediate-frequency reference signal 213 or IF reference signal 213, and which is at the first intermediate frequency f_{IF1}=f_{Ref1}−f_{Mod}, with combination phase noise superimposed thereon. The combination phase noise has the superimposition of the first phase noise from the PLL1 and the second phase noise from the PLL2. The IF reference signal is used as the signal 213 both for controlling the PLL2 and as the basis for the sampling clock fₛ.

The mixing of the received signal RX (shifted in time through t with respect to the transmitted signal TX but, like the transmitted signal TX, at the frequency f_{Mod}) and of the first reference signal 221 in the mixer M2 results, after filtering 204 and amplification 205, in the intermediate-frequency received signal 206 or the IF received signal 206, which is at the first intermediate frequency f_{IF1}=f_{Ref1}−f_{Mod} and has combination phase noise of the first phase noise from the PLL1 and the second phase noise from the PLL2. In general, the output signal from the mixer M2 may also be referred to as the intermediate-frequency received signal 206.

Therefore, the IF reference signal 210, 213, 215a, 215b and the IF received signal 206 essentially have phase noise of the same type, that is to say the combination phase noise, and are thus correlated, even though the phase noise of the PLLs PLL₁, PLL₂ is not correlated. At the least, the combination phase noise of the IF reference signal 210, 213, 215a, 215b and of the IF received signal 206 for received signals is essentially correlated, if the propagation times τ are short. In consequence, an IF received signal 206 is sampled using one sample signal 215a, 215b in each case, whose phase noise is essentially correlated with the phase noise of the IF received signal.

Because of the structure of the receiver 107, the final received signal 206, 206′ has the characteristics of the suppressed phase noise after sampling using fₛ in the digital signal preprocessing 207. Since the first reference signal 221 is at a frequency that is shifted through f_{IF1} with respect to the transmission frequency f_{Mod}, the mixing of the reference signal 221 with the received signal at the frequency f_{Mod} results in the transmitted/received frequency f_{Mod} being converted essentially to the intermediate frequency f_{IF1}.

Essentially, this therefore leaves the first intermediate-frequency received signal 206 with the combination phase noise from the two frequency generators PLL1, PLL2.

The phase noise from the two or more frequency generators PLL1, PLL2 in the intermediate-frequency signal 206 can in consequence be eliminated in at least two ways.

On the one hand, the intermediate-frequency signal 206 can be sampled using a sample signal 215a, 215b, which likewise contains the first intermediate frequency f_{IF1} with the combination phase noise, in the same sense.

Alternatively, the intermediate-frequency signal 401 can be mixed with a signal 405, which has been formed from a stabilized second intermediate frequency f_{IF2} and the first intermediate frequency f_{IF1}. This is illustrated in FIG. 4a.

The wide frequency range of a UWB signal may distribute a signal over a very large number of frequencies and may therefore be more reliable than a comparably narrowband signal, since the failure of or disturbance with individual frequencies may be significantly less significant in comparison to the overall bandwidth. The frequency used may be dependent on the application. For example, a 20 GHz signal may be less suitable for measurement of tubes in a wall than a 1 GHz signal, since a 20 GHz signal may be subject to high attenuation in a wall. The wider the bandwidth is, the better resolution the UWB apparatus 100 can provide, that is to say the thinner the layers which may be investigated. By way of example, a 1 GHz signal can achieve an optical resolution of 15 cm. A 2 GHz signal actually achieves a resolution of 7.5 cm, that is to say objects at a distance of 7.5 cm from one another can be resolved. The resolution is therefore inversely proportional to the frequency used by the PLLs.

In other words, a method and an apparatus for provision of a reflection signal may thus be provided, wherein a first reference signal 221 is produced by mixing M2 of two output signals 220, 221 from frequency generators PLL1, PLL2, and wherein the first reference signal 221 is used for demodulation M2 of a received signal RX.

As already mentioned, a heterodyne radar system has two oscillators. The PLL1, 200 or PLL₁, 200 is part of the transmission signal device 101 or of the transmitter 101. The offset PLL PLL2 201 or PLL₂ 201 produces the reference signal f_{Ref1} for the receiver 107.

The single-heterodyne UWB radar system 100 has a first regulated radio-frequency oscillator PLL1, 200 for production of the stepped modulation ramp 300 at the frequency f_{Mod}. The output signal 220 from the PLL1, 200 is supplied and sent via an output amplifier 202 and the transmission/reception diplexer 102 or directional coupler 102 and the low-pass filter 203 to the antenna 103. The low-pass filter 203 is used to suppress undesirable harmonics.

The first radio-frequency oscillator PLL1, 200 is contained in the transmission device 101.

The second regulated radio-frequency oscillator PLL2, 201 is contained in the reception device 107 and produces the first reference signal f_{Ref1}. The frequency of the reference signal f_{Ref1} is a ramp shifted through f_{IF1} in frequency with respect to the frequency of the transmitted signal f_{mod}.

The received signal RX which, like the transmitted signal TX, is at the frequency f_{Mod}, is mixed with the reference signal f_{Ref1} in the mixer M2, and is supplied to a first intermediate-frequency filter 204 and an amplifier 205. The received signal RX is provided, by the mixing in the mixer M2 and the first intermediate-frequency filter 204, which is in the form of a bandpass or low-pass filter, as a received signal whose carrier frequency is f_{IF1}, or as a received intermediate-frequency signal, at the interface 206, of the digital signal preprocessing 207. In other words, because f_{Ref1} contains the modulation frequency f_{Mod} in the same way that the received signal RX contains the modulation frequency f_{Mod}, the mixer M2 carries out conversion to the intermediate frequency f_{IF1} by means of the convolution of f_{Mod} that is carried out in the frequency domain by the mixer. This conversion results in the received signal now having a carrier frequency of f_{IF1} rather than f_{Mod}. In this context, the carrier frequency means that f_{IF1} represents the intermediate frequency or carrier frequency of the useful signal RX.

As can be seen from FIG. 2a, a received signal 206 at the carrier frequency f_{IF1} is made available directly to the digital signal preprocessing 207 at the interface 206. As can accordingly be seen, essentially no analog conversion (that is to say essentially analog components) of the received signal at the carrier frequency is carried out to baseband, and, instead, the digital signal preprocessing 207 directly accesses the useful signal RX on the carrier. Thus, in the case of direct sampling, access is made directly to a signal 206 on the carrier.

The frequency regulation in the first radio-frequency oscillator PLL1, 200 is implemented with the aid of a standard PLL circuit. In this standard PLL circuit, the radio-frequency signal f_{Mod} is regulated at the external crystal frequency f_{Q} 208 via a frequency divider and a phase detector (PFD). The frequency divider and the phase detector in the PLL1 are not illustrated in FIG. 2a. The external crystal frequency f_{Q} is converted to a clock signal or square-wave signal via the clock generator G, 209, and is made available via the illustrated link to the PLL1.

The clock signal from the clock generator 209 is also made available in parallel to the PLL2. The PLL1 and the PLL2 therefore run or are based essentially on the same clock, but with an appropriate frequency offset, which corresponds to the first intermediate frequency f_{IF1}.

There is no need for a radio-frequency divider in the second radio-frequency oscillator PLL2, because the second radio-frequency oscillator PLL2, 201 can be regulated at the desired reference frequency f_{Ref1} via the crystal frequency f_{Q} and the mixed signal IF₁, 210 at the frequency f_{IF1}, which is used at the output of the mixer M1. The mixed signal IF₁ may be in the MHz range, while the stepped modulation of the PLL1, 200 may be in the form of a UWB signal in a lower GHz range.

After the low-pass filtering 212, the signal 213 is essentially at the actual intermediate frequency f_{IF1}, which may also differ somewhat from the nominal IF frequency f_{IF1}, in particular during stabilization of the two PLLs PLL1, PLL2.

In one preferred embodiment variant of the invention, the frequency profile of the PLL2 therefore represents a ramp 300 shifted through the intermediate frequency f_{IF1}.

The transmission signal TX is not only passed from the coupling point 211 at the modulation frequency f_{Mod} or transmission frequency f_{Mod} in the direction of the antenna 103, but is also fed back to the PLL1, in order to regulate the phase of the PLL1, 200. Furthermore, a signal at the frequency f_{Mod} is passed to the mixer M1. In the mixer M1, the transmission signal at the frequency f_{Mod} is mixed with the reference signal at the frequency f_{Ref1}=f_{Mod}−f_{IF1}, thus resulting in a signal which has only the frequency f_{IF1} in the frequency domain, after low-pass filtering by means of the low-pass filter IF₁, 212. This low-pass-filtered signal is used as a control signal for the PLL2, 201, in order to obtain the staircase function, shifted through the frequency f_{IF1}, of the PLL2. In other words, the output function or the output frequency profile of the PLL1, 200 and of the PLL2, 201 corresponds to the stepped ramp 300, which is regulated at the PLL1.

Since, because of the internal circuitry of the PLL2, 201, the frequency profile of the signal of the PLL2 corresponds to the frequency profile 300 of the signal from the PLL1, which is simply shifted through the shift frequency f_{IF1} or intermediate frequency f_{IF1} filtered via the low-pass filter IF₁, 212, the stepped ramp 300 of the PLL2 lags behind the stepped ramp 300 of the PLL1 by f_{IF1} in the frequency domain, and is at a correspondingly higher or lower frequency. Therefore, while the transmission signal TX starts to oscillate at the modulation frequency f_{mod} which corresponds to the respectively current step on the stepped ramp 300, the PLL2 produces a reference signal f_{Ref1} at a frequency increased or decreased by f_{IF1}. The frequency f_{IF1} therefore represents an offset for the stepped ramp 300, which shifts the stepped ramp 300, which is applicable to the PLL2, by the amount of the offset along the frequency axis.

The intermediate-frequency signal produced by means of the low-pass filter IF₁, 212 is passed on via the connection 213 to a splitting device 214. The splitting device 214 splits the intermediate-frequency signal at the frequency f_{IF1} into two signals which are phase-shifted essentially through either +90° or −90° with respect to one another, with the actual difference frequency f_{IF1} or intermediate frequency f_{IF1}. Alternatively, expressed in other words, the splitting device 214 produces two physically parallel signals 215a and 215b, with the signals in the signal paths 215a and 215b being at the intermediate frequency f_{IF1} or the sampling frequency fₛ=f_{IF1} for the A/D (analog/digital) conversion in the digital signal preprocessing 207. However, the signals in the parallel channels 215a, 215b are shifted through +/−90° in time with respect to one another, that is to say there is a phase of +/−90° between them. In other words, with respect to a phase of 0° in a channel 215a, the other channel 215b has a phase of +90° or −90°. The signals in the parallel branches 215a, 215b have a phase shift of +/−90° with respect to one another.

These parallel signals, which are shifted with respect to one another, can be supplied to the digital signal preprocessing 207 in order to break down or demodulate the received signal 206, which is likewise obtained at the intermediate frequency f_{IF1} at the output 206, into an in-phase component I and a quadrature component Q. Since both the received intermediate-frequency signal 206 on the line 206 as well as the first sample signal and the second sample signal in the channels 215a and 215b are essentially at the actual intermediate frequency f_{IF1}, the digitizing process in the digital signal preprocessing 207 is carried out with the bandpass signal 206, or at the IF level.

It should be noted here that, in general, the reference numbers of connections or interfaces, such as the reference number 206, may also refer in this text to a signal which is carried by the respective connection.

The signal produced by the digital signal preprocessing 207 may be made available to the data processing unit 216 or to the microcontroller (μC) 216 for further processing.

FIG. 2b shows the design of the PLL1. The stabilized crystal frequency f_{Q} is made available to the 1/M1 divider 253, and is passed on to the phase frequency detector 251. The phase frequency detector (PFD) 251 also receives the transmission signal 220, which has been fed back via the radio-frequency 1/N1 divider 254, at the transmission frequency f_{Mod}. (The signal passed from the node point 211 to the mixer M1 is not shown in FIG. 2b). The ratio of the programmable integer divider coefficients N1 and M1, which can be varied over time, governs the frequency profile of the PLL. A digital controller 250, 450 can vary the coefficients so as to pass over the ramp 300 as illustrated in FIG. 3 over the time profile, that is to say the associated frequencies are adopted over the time profile.

After the PFD 251, the signal is passed to the loop filter 252 which determines how quickly stabilization will occur in the event of a sudden change between the steps f1, f2 of the ramp.

The generator 255 produces the transmission signal 220 at the frequency f_{Mod}. The PFD 251 receives a radio-frequency signal in the GHz range via the divider 254. The PFD 253 receives a signal at a low frequency f_{Q} (in the MHz range) of the crystal 208 via the divider 253.

The second frequency generator PLL2 is illustrated in FIG. 2c. The 1/N2 divider 264 does not receive any signal fed back from the PLL PLL2, but receives the IF signal 213 at the frequency f_{IF1}. This frequency f_{IF1} is in the MHz range. In other words, the first reference signal 221 is at a frequency f_{Ref1} which is a transmission frequency f_{Mod} shifted through the first intermediate frequency f_{IF1}.

The 1/M2 divider 263 receives the stabilized crystal signal f_{Q}, which is also in the MHz range. The outputs of the dividers 263, 264 are connected to the PFD 261. The divider coefficients M2 and N2 are integers and are programmable, for example via the digital controller 250, 450. Since the divider 264 receives the IF signal 213, it regulates at the IF frequency f_{IF1}. The value of IF1, that is to say the value of the shift with respect to the frequency profile 300 of the PLL1, is governed by the choice of the coefficients M2, N2.

The output signal from the PFD 261 is passed to the loop filter 262 and from there to the generator 265 which, for example, determines the ramped profile of the first reference signal 221 of the PLL2. In this case, PLL2 lags behind PLL1.

Since the frequency f_{Mod} of the transmission signal has a ramped frequency profile 300 as shown in FIG. 3, and since the intermediate frequency f_{IF1} is an essentially constant frequency, the time profile of the reference frequency f_{Ref1} also has a ramped profile after the subtraction process f_{Ref1}=f_{Mod}−f_{IF1}. The time frequency profile illustrated in FIG. 3 can also be referred to as frequency modulation 300. As explained in more detail in FIG. 2b, this frequency modulation 300 can be achieved by varying the timing of the divider coefficients N1 and/or M1.

The adjustment of the timing of the divider coefficients N1 254 and/or M1 253 or else the divider coefficients N2 264 and/or M2 263 may be achieved by appropriately designed controllers 250, 450.

The divider 264 operates at a lower frequency than the divider 254, which leads to the power consumption of the divider 264 being less than that of the divider 254.

FIG. 4a shows a schematic block diagram of a double-heterodyne UWB radar system. The design corresponds essentially to the design of the single-heterodyne UWB radar system shown in FIG. 2a. However, the double-heterodyne radar system 400 has a second conversion of the received signal to a second intermediate frequency f_{IF2}. The second intermediate frequency f_{IF2} is lower than the first intermediate frequency f_{IF1}. Because of the additional conversion, the double-heterodyne radar system has fewer components in the RF analog section than the single-heterodyne system, however, that is to say in the circuit upstream of the digital signal preprocessing 207′.

The received signal RX likewise passes through the low-pass filter 217 and the amplification 218 before being mixed in the mixer M2 with the reference signal f_{Ref1} produced by the PLL2. The received intermediate-frequency signal or IF received signal which is produced by the mixer M2 and is now provided with the carrier IF₁ is made available to the mixer M4 via the connection 401. However, the signals produced by the splitting device 214 in the two channels 215a, 215b are not made directly available as a clock signal to the digital signal preprocessing 207 as in the single-heterodyne case. In fact, these two signals 215a, 215b in the double-heterodyne system are made available to a single-sideband mixer (ESB) M3, which may relate either to the lower sideband (USB) or the upper sideband (OSB).

The division by the division element 402 results in the clock signal generated by the clock generator 209 being made available to the mixer M3 as the second intermediate-frequency signal at the frequency f_{IF2} on both channels 403a, 403b with a phase difference of 90° between the two signals. The intermediate frequency f_{IF2} is therefore derived by division of the crystal frequency f_{Q} by the factor M. The crystal 208 is the frequency-stabilizing element. The frequency generator 209, G, for example a square-wave frequency generator, produces the frequency f_{Q} on which all the signals in the UWB radar system 100 are based, for example including the clock signal 404 for the digital preprocessing 207′.

The division process is carried out in the frequency divider 402 such that two clocks are produced, which are shifted through ¼ of a clock cycle or through 90° in time with respect to one another. In other words, the divider 402 not only makes the clock signal parallel but also at the same time, in a comparable manner to the splitting device 214, produces a shift in the time signals through ¼ of a clock cycle, through 90° or through n/2.

The crystal frequency f_{Q} is also distributed via the line 404, and is used as the clock for the digital signal preprocessing 207′, which digitizes and preprocesses the received signal RX 206′, whose carrier frequency is the second intermediate frequency f_{IF2}, or the received intermediate-frequency signal 206′, whose carrier frequency is the second intermediate frequency f_{IF2}. In particular, the signal preprocessing 207′ demodulates the received signal RX.

The parallel channels 215a, 215b which contain the signal at the intermediate frequency f_{IF1}, and the parallel channels 403a, 403b which contain the second intermediate-frequency signal, whose frequency has been reduced to the frequency f_{IF2}, are converted via the single-sideband mixer M3 to the second reference signal f_{Ref2} 405, which is at the frequency f_{Ref2}=f_{IF1}+/−f_{IF2}. The second reference signal may therefore be at the frequency f_{Ref2}=f_{IF1}+f_{IF2} or f_{Ref2}f_{IF1}−f_{IF2}. In other words, the second reference frequency is shifted with respect to the first reference frequency, that is to say it is either higher or lower than the first reference frequency. This means that the first reference frequency and the second reference frequency are not the same. The second reference signal 405, at the second reference frequency f_{IF2}, is made available on a single channel. This means that the parallel channels 215a, 215b, 403a, 403b have been combined onto one channel by the mixer M3. During mixing of signals, for example in the mixers M1, M2, M4, signals can be created with the frequency pairs f1-f2 and f1+f2, that is to say by way of example by f_{Mod}−f_{Ref1} and f_{Mod}+f_{Ref1}. Therefore, each mixing process may also include filtering by means of an associated filter in order to provide only one of the frequency pairs, for example filtering using the filter 212, 204, 208.

The method of operation of a single-sideband mixer (SSB) is illustrated in FIG. 4b. The divider 1/M 402 makes a signal at the second intermediate frequency available in a channel 403a, and a signal with a phase shifted through +90° or −90° with respect to the first channel 403a available in the other channel 403b (FIG. 4b shows a signal shifted through)+90°. The two signals 403a, 403b are each mixed with a signal 215a at the first intermediate frequency, and with a signal 215b likewise at the first intermediate frequency, and at a phase angle shifted through either +90° or −90° with respect to the phase angle of the signal 215a, and are combined by means of an adder 420 on a line 405, such that the second reference signal is produced at the second reference frequency f_{Ref2}=f_{IF1}+f_{IF2} or f_{Ref2}f_{IF1}−f_{IF2}.

In the mixer M4, the second reference signal at the frequency f_{Ref2} is mixed with the received signal RX, 401 whose carrier frequency is f_{IF1}, and the received signal, now at the second intermediate frequency f_{IF2} as the carrier, is produced at the output 406 of the mixer M4. In other words, this means that the single-sideband mixer M3 in combination with the further mixer M4 and the bandpass (BP) filter 408 convert the received signal RX to the second, lower intermediate frequency f_{IF2}<f_{IF1}. This received signal 406, whose carrier frequency is f_{IF2}, can be made available via amplification 407 and a bandpass filter 408 matched to IF₂ via the output 206′ on the digital signal preprocessing 207′. The sequence of amplification 407 and of the bandpass filter 408 can be interchanged. The result of the measurement signal that has been preprocessed in the digital signal preprocessing 207′ is then transmitted, for example, via an SPI interface (serial peripheral interface) 208 to a downstream control unit and/or data processing unit μC, or the microcontroller 216.

The specific way in which the two reference signals f_{Ref1} and f_{Ref2} are produced and the specific way in which the received signal RX is demodulated make it possible to prevent stabilization effects of the two PLLs PLL1, PLL2 affecting the phase angle of the demodulated received signal RX, making it possible to minimize the influence of phase noise from the PLLs PLL1 and PLL2. In other words, this means that the phase noise of the oscillators or of the PLLs PLL1, PLL2 is admittedly not mutually correlated. However, because the two signals 401, 405, which are both at the frequency f_{IF1} and therefore have essentially the same phase errors, particular the same combination phase errors, are mixed with one another, the same phase errors are largely compensated for. The signals 401, 405 are based on signals which propagate on different paths within the radar system 100, 400. Therefore, the signals 401, 405 are essentially merely shifted in time with respect to one another by a propagation time τ of the radar signal in the radar channel. τ may be the propagation time from transmission of a signal TX to reception of a signal RX. The shorter the propagation time τ is, the better the correlation between the two signals 401, 405 may be. In the limit case, where the propagation time is Σ=0, the signals 401, 405 are essentially identical, when considered in time.

The phase noise in the signals 401 and 405 is essentially approximately correlated, because it is based on the same signals. Therefore, phase errors have an identical effect in the various branches of the circuit, and essentially cancel one another out. This results in essentially coherent signals at a standard phase angle, allowing a high signal-to-noise ratio.

The UWB measurement system 100, 400 supplies to the downstream data processing unit 216 the transmitted signal RX, which has been reflected on the measurement object 104, at the output 208 as a function of the modulation frequency f_{Mod} or of the transmission frequency f_{Mod}. The received signal RX is likewise at the transmitted frequency f_{Mod}. The received signal RX preferably has a signal bandwidth in the kHz range.

The transmission/reception decoupling or transmission/reception isolation is achieved with the aid of a directional coupler 102. The directional coupler 102 passes the received signal RX on from the antenna 103 to the receiver 107 with minimal attenuation. In the transmission direction, that is to say from the PLL1 in the direction of the antenna 103, the transmission signal TX is fed into the antenna with a typical attenuation of 6 dB. The transmission signal which is not fed into the antenna is terminated on the terminating impedance 108.

In a further exemplary embodiment of the UWB system, that is to say for example of the single-heterodyne UWB system or of the double-heterodyne UWB system, the transmission power may be varied with the aid of a variable transmission amplifier. For example, the transmission amplifier 202 may be designed to have a variable gain. This measure allows matching to specific circumstances, in particular to licensing regulations, which allow only a specific transmission power, depending on the operating frequency f_{Mod}.

In a further exemplary embodiment of the present invention, a plurality of transmission channels and/or reception channels may be provided, which allow simultaneous operation of a plurality of antennas 103 or of an antenna array (for example with different polarization). By way of example, a plurality of antennas may lead to better results for material identification or for line detectors.

The stepped modulation f_{Mod} is designed such that it can be measured externally.

It may be an aspect of the invention to provide an ultra-wideband radar system having a modulation PLL PLL1 and an offset PLL PLL2, and two-stage (double-heterodyne) conversion of the received signal RX to a second, lower intermediate frequency f_{IF2} using the actual difference frequency f_{IF1}=±(f_{Mod}−f_{Ref1}) between the two PLLs PLL1, PLL2. The intermediate-frequency reference signal 213 is at the frequency f_{IF1}. The received signal after mixing by means of the mixer M2, that is to say the received intermediate-frequency signal, is likewise at the frequency f_{IF1}. The signal 213 may be used as an internal reference with respect to the variable received signal RX or Rx. The received signal may have been changed on its path in the radar channel 105, 106. The signal 213 may help to indicate the difference between the signal 213 and the received signal Rx.

Furthermore, one aspect of the present invention may be to provide an ultra-wideband radar system having a modulation PLL PLL1, an offset PLL, PLL2 and single-stage (single-heterodyne) conversion of the received signal RX to a first intermediate frequency f_{IF1}, and in this case to provide the actual difference frequency f_{IF1} between the two PLLs for clocking of the digital signal preprocessing 207.

Splitting of the clock signal into the two channels 215a, 215b in the single-heterodyne case makes it possible to process a received signal 206 at a high intermediate frequency directly, by the high-frequency IF signal being broken down into two signal components I and Q within the digital signal preprocessing 207. This means that there is no need for a second mixer stage. However, a high-speed A/D converter is required for sampling of the high-frequency IF signal. High-quality A/D converters could therefore be required for sampling, and are subject to stringent requirements.

On the other hand, in the case of the double-heterodyne UWB radar system, the conversion to a low intermediate frequency f_{IF2} without parallel breakdown allows the signal, whose carrier frequency is the low intermediate frequency f_{IF2}, to be made use of directly. The digitizing process can therefore be carried out using only a single analog/digital converter, which is not subject to stringent requirements, and splitting into the I/Q components can in turn be carried out at the digital level.

It is therefore possible to provide for at least two IF signals, that is to say at least two signals at the frequency f_{IF1}, to be produced, and for these to be distributed on different paths in the circuit. The propagation of the signals on different paths makes it possible to compare a reference signal with a received signal. On the other hand, by way of example, the two signals may be combined by sampling or mixing, thus making it possible to eliminate any phase error which is present uniformly in the two signals.

A received signal 206 with a carrier frequency of f_{IF1} can therefore be sampled using an IF signal 215a, 215b. In this case, the two signals 206, 215a, 215b contain the IF frequency f_{IF1} and essentially the same phase noise or combination phase noise. It is therefore possible to essentially mutually cancel out the phase noise.

On the other hand, a received signal 401 whose carrier frequency is f_{IF1} can be mixed with a second reference signal 405 at the second intermediate frequency f_{Ref2}, thus making it possible to produce a received signal 206′ whose carrier frequency is a second intermediate frequency f_{IF2}. This received signal then contains an essentially exact IF (intermediate frequency) f_{IF2}. The phase noise contained in the intermediate frequency f_{IF1}, or the combination phase noise contained therein, is also cancelled out during the mixing process.

A signal may be converted to an intermediate frequency f_{IF1} in a first stage 101, 107, in an analog section 101, 107 or in an RF (radio-frequency) section 101, 107 of a circuit, thus essentially eliminating the influence, and in particular disturbances, of a transmission frequency f_{Mod} from the signal. The received signal 206, whose carrier frequency is f_{IF1}, may, however, still contain disturbances which occur during the generation of the intermediate frequency f_{IF1}.

These errors in the intermediate-frequency signal 206 can be essentially removed by, in one example, sampling the intermediate-frequency signal 206 using a sampling signal 215a, 215b which contains essentially the same errors as the intermediate-frequency signal 206.

The errors in the intermediate-frequency signal 401 can essentially also be removed, in another example, by mixing the intermediate-frequency signal 401 onto a further intermediate-frequency signal 406, 206′ or second intermediate-frequency received signal 406, 206′. During this mixing process, the mixer M4 receives the intermediate-frequency signal 401 and a further input signal 405, which is at the first intermediate frequency f_{IF1} or the further intermediate frequency f_{IF2}. The further intermediate frequency f_{IF2} is in a sufficiently low frequency range that it can be sampled using simple components.

A method and an apparatus may therefore be specified for provision of a reflection signal, wherein a first reference signal 221 is produced, inter alia, by mixing the two output signals from two frequency generators PLL1, PLL2, and wherein the first reference signal 221 is used for demodulation M2 of a received signal RX and for generation of the sampling clock, or for production of a second reference signal 405 for further demodulation M4 of the received signal.

In one example, the first intermediate-frequency received signal 206 together with the sampling clock 215a, 215b may be provided to downstream signal preprocessing, in each case at the first intermediate frequency f_{IF1}. The intermediate-frequency received signal 206 can be provided at an output, and the clock signal 215a, 215b with the output clock may be provided at two separate outputs.

In another example, a second intermediate-frequency received signal 406, 206′ may be provided together with a clock 404 for clocking of the digital signal preprocessing 207′, which may be at the frequency f_{Q}. In particular, the sampling clock can be produced by division of the clock signal 404 in the signal preprocessing 207′. The clock 404 can also be used to produce the second intermediate frequency f_{1F2} by division 402 by the factor M. The second intermediate-frequency received signal 406, 206′ and the clock signal 404 may each be provided at one output. The second intermediate frequency f_{IF2} may be provided at two outputs 403a, 403b.

FIG. 4c shows three block diagrams 461, 462, 463 of the first stage 804a of the decimation filter arrangement 505 according to one exemplary embodiment of the present invention.

The first block diagram 461 in FIG. 4c illustrates the design of the first stage 804a of order K₀ of two-stage decimation or of a two-stage decimation device 804, 805, 505.

The conventional decimation filter of order K₀ 470, which has the first FIR filter FIR₁ 464 and the clock reduction device OSR 465, forms the first part of the first decimation device 804a. In this arrangement, the order K₀ expresses the number of individual feedback elements 464a and forward coupling elements 464b when the decimation filter 462 is in the form of a CIC or a sinc filter.

The feedback elements 464a or integration filter elements 464a result in an added value delayed by a time step z⁻¹ being added to a current input value. The forward coupling elements 464b or differentiation filter elements result in a value delayed by a time step z⁻¹ being added to a current value, with the delayed value being provided with an inverted mathematical sign before the addition process. The forward coupling elements 464b differentiate the output values of the clock reduction device OSR 465. The feedback elements 464a integrate the input signal. The integration method used may be a very simple numerical integration method, thus simplifying the provision of an appropriate filter.

For example, a decimation filter of order K₀=3 has three (K₀) feedback elements 464a, three (K₀) forward coupling elements 464b, and a single clock reduction device 465. The block diagram 462 in FIG. 4c illustrates this embodiment variant, including the additional filter FIR₂.

In the signal propagation direction, the FIR₂ filter is therefore connected to a decimation filter which has the same number of integration filters 464a and differentiation filters 464b, and one and only one clock reduction device 465.

The limit of the number of steps can be defined by the order of a decimation filter. One step of a decimation filter may extend from the first integration filter 464a, 604a to the last differentiation filter 604b, 464b, with this number being predetermined by the order. This makes it possible to define a multi-stage filter design.

The conventional decimation filter 464, 465 may be a sinc filter, sinc^{K0} filter or CIC filter (cascaded integrator-differentiator filter), for example of order K₀.

A sinc decimation filter or sinc( ) decimation filter can be inserted into two parallel channels with a parallel configuration. The two channels may be referred to as the I-channel and the Q-channel.

In order to avoid repetitions, the following text describes only a sinc decimation filter, which may be used both in the I-channel and in the Q-channel. In the case of a sinc decimation filter of order K₀, an input signal is added K₀ times in an adder to a signal with the same sequence delayed by a time step (z⁻¹) (feedback element 464a), and is made available to a clock reducer with the factor OSR (↓OSR) 465 or N(↓N). The signal reduced in this way in the clock cycle is undelayed K₀ times, is delayed by a time step (z⁻¹) and is made available, multiplied by −1, to an adder (forward coupling element 464b). The output signal from the last adder also forms the output signal from the sinc decimation filter, in particular one channel of the sinc filter, with the frequency or the clock cycle of the output signal having been reduced by the factor OSR or N. This implementation of the conventional decimation filter with a downstream FIR filter FIR₂ 466 is illustrated in the block diagram 462 in FIG. 4c. In this case, the series-connected filters 464c correspond to the FIR filter FIR₁, 464 in the block diagram 461.

A conventional sinc^{K0} decimation filter with the decimation factor OSR and the order K₀ forms, mathematically speaking, the sum or the mean value over a number of OSR successive sample values in each time step or clock cycle. This corresponds to an FIR filter with a number of the same coefficients corresponding to the decimation factor OSR, for example B=[1, 1 . . . , 1], or B=[1, 1, 1] when OSR=3. This addition process is repeated K₀ times. The sampling rate is then reduced by the factor OSR. This implementation of the conventional decimation filter is likewise illustrated in the block diagram 463 in FIG. 4c.

In the implementation, this function (sampling rate reduction by the factor OSR) can preferably be implemented in an efficient structure as shown in the block diagram 462.

The second part of the first decimation device 470, 464, 465 has the additional FIR filter FIR₂ 466. By way of example, the additional FIR filter is in the form of a filter with the filter coefficients B=[1, 2, 1]. These filter coefficients produce a function b₀+b₁z⁻¹+b₂z⁻², where b₀, b₁, b₂ correspond to the filter coefficient vector B.

The block diagram 463 shows a further alternative embodiment variant of the first decimation device 804a. This embodiment variant differs from the embodiment variant shown in the block diagram 462 in the computation accuracy and in the implementation complexity. This equivalent structure 463 is based on the mathematical equivalent notation

$${\sum }_{k = 0}^{N - 1} {z}^{- k} = \frac{{s}^{- N} - 1}{{s}^{- 2} - 1} .$$

Further implementations are also possible. In the arrangement shown in the block diagram 463, the order K₀ expresses how many individual filter elements 464c the FIR filter FIR1, 464 has.

The conventional decimation filter of order K₀ 464, 465 according to the embodiment in the block diagram 463 has addition blocks 464c repeated a total of K₀ times, and one and only one single clock reduction element 465. The K₀ addition blocks 464c have a number of OSR-1 delay elements z⁻¹ 467 connected in series. In other words, an input is provided for the adder 468 for each clock cycle by which the clock reduction element OSR 465 or the clock reduction device OSR 465 reduces a clock signal. An FIR filter or an addition block 464c forms the sum of the number of OSR-1-delayed clock values and the undelayed signal. The number OSR may in this case be the number of clock cycles by which the OSR element 465 delays the clock signal. The current signals of the clock signals are tapped off upstream and downstream of the delay elements 467 in a signal propagation direction, and are supplied to the adder 468. The added signals are used as an input for the downstream stage of the addition blocks 464c.

The second decimation filter 805 (not shown in FIG. 4c) has a similar structure to that of the first decimation filter 804a. However, the second decimation filter 805 does not have K₀ addition blocks 464c, but K₁ addition blocks. The numbers K₀ and K₁ may be dependent on the design requirements of a filter circuit (requirements and the transfer function of the filter). In other words, the second decimation filter 805 is a decimation filter of order K₁, with the decimation factor N and an additional hold input 807.

K₀ may differ from K₁. The product of the values OSR and N corresponds to a total clock reduction which allows an intermediate-frequency received signal 206, 504i, 504q to be converted from a sampling clock rate f_{IF1} or from a high internal clock rate used for quantization in a modulator 502i, 502q essentially to a lower clock rate, which is suitable for representation of the useful signal, taking account of the sampling theorem, corresponding to the bandwidth of the useful signal. In this case, disturbing signal components and noise, in particular outside the bandwidth of the useful signal, are largely suppressed.

The described specific type of sampling by the modulators 502i, 502q with the sampling clocks 215a, 215b results essentially in I/Q demodulation with conversion of a signal 206, whose carrier frequency is an intermediate frequency, to a complex-value I/Q signal in baseband, without a carrier.

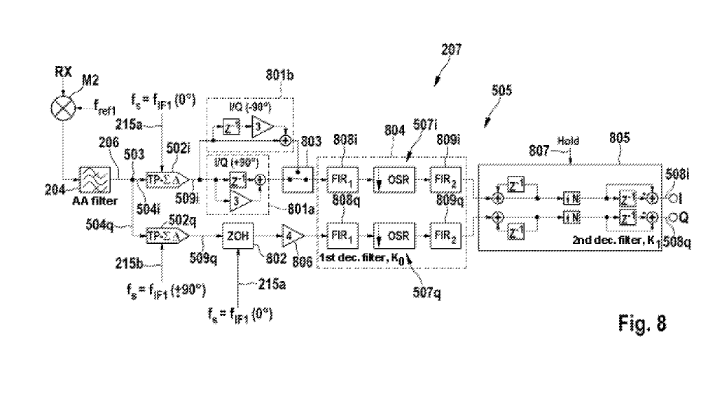

Although FIG. 4c or FIG. 8 describe only one channel, a two-stage filter design may be used in a multiplicity of parallel channels, for example in the case of the parallel configuration of I/Q channels. The second stage 805 of the two-stage decimation filter is described in FIG. 8.

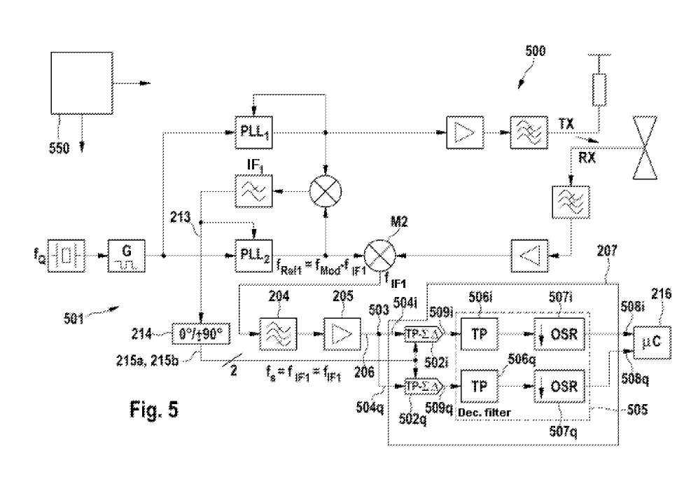

FIG. 5 shows a single-heterodyne UWB system 500, in which the analog section 501 (that is to say that part of the circuit up to the connection 206 of the digital section 207) corresponds essentially to the single-heterodyne UWB system shown in FIG. 2.

The digital section 207 or the digital signal preprocessing 207 will be considered in more detail in the following text. The digital section 207 is based on the so-called principle of direct sampling of an intermediate-frequency signal. The use of direct sampling makes it possible to reduce the implementation complexity for integration in an integrated circuit (IC). For example, the use of the principle of direct sampling makes it possible to reduce the complexity for the implementation, in terms of the area required for integration of the IC.

The principle of direct sampling provides for a change to be made to digital components as early as possible in the demodulation chain of the receiver 107. The use of digital components avoids the need for analog components, and therefore avoids the problems resulting from tolerances, matching, etc., of the analog circuit parts that are replaced, thus making it possible to avoid errors. A functionality is therefore moved from analog circuit parts to the digital section 207. Direct sampling also makes it possible to minimize the power consumption of a corresponding UWB apparatus or of an IC (integrated circuit).

In the digital section 207 shown in FIG. 5, the signal evaluation was designed such that undesirable signals are essentially suppressed by high attenuation, using the principle of direct sampling with little implementation complexity.

A bandpass signal of the received signal RX, the intermediate-frequency signal or IF received signal is provided at the input 206 of the modulators 502i, 502q or the connection 206 of the modulators 502i, 502q to the amplifier 205. In other words, the digital section 207 receives a received signal RX, whose carrier frequency is the IF (intermediate frequency) f_{IF1}, via the input 206 from the upstream analog section. This signal on a carrier may still be at a relatively high frequency level f_{IF1}—in comparison to the output signal 508i, 508q. In order to allow this signal 206 to be processed further using simple analog/digital converters, it would, for example, have to be down-mixed to baseband.

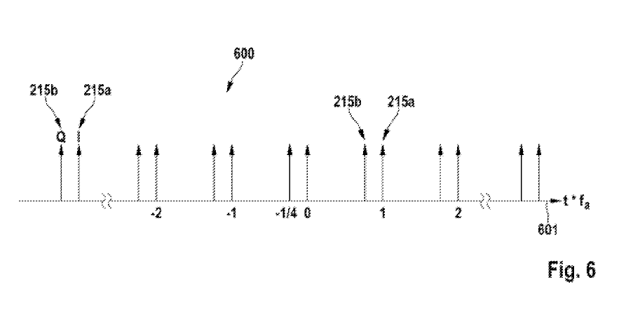

In order to allow the radio-frequency received intermediate-frequency signal 206 to be processed further directly digitally by means of direct sampling, the received intermediate-frequency signal 206 is split into two channels 504i and 504q via the splitting device 503, and is passed on equally to the analog/digital converters 502i and 502q, or to the delta-sigma modulators 502i, 502q. The splitting device 503 may be a Y-element, which copies the input signal to both channels. Instead of a Y-element, the received intermediate-frequency signal 206 may be sampled directly using two different sampling clocks 215a, 215b and different modulators 502i, 502q. The different sampling clocks are described in more detail in FIG. 6.

Essentially the same intermediate-frequency signal 206 is therefore applied to the inputs of the two analog/digital converters 502i, 502q.

In general, connections, signals which are passed via the connections, and/or inputs of function blocks or of blocks may be annotated with the same or similar reference symbols in the following description of the figures. Furthermore, for the sake of simplicity, a signal may be referred to using the associated reference symbol of the respective channel.

The sampling clocks of the two analog/digital converters or analog-to-digital converters (ADC, A/D converters) 502i, 502q correspond essentially exactly to the actual intermediate frequency, or sampling frequency fₐ=fₛ=f_{IF1}. The sampling clocks are provided as a first clock signal 215a and as a second clock signal 215b. The intermediate frequency f_{IF1} corresponds essentially to the difference frequency between the two signal generators, the two frequency generators or the two PLLs PLL1 and PLL2, and is derived via the shift element 214 or the splitting device 214 from the difference frequency between the two PLLs. The shift element 214 may be integrated in a sampling device 502i, 502q, in such a way that the sampling device 502i, 502q receives the intermediate-frequency reference signal 213 via a single input. In consequence, the digital signal preprocessing 207 has an input for the sampling clock. The digital signal preprocessing 207 may, however, also have at least two inputs 215a, 215b, via which it receives the shifted sampling clock signals 215a, 215b.

Sampling with different phases (that is to say with time-shifted signals) results in phase-shifted channel signals or time-shifted channel signals 509i, 509q being formed from the intermediate-frequency signal 206. In other words, this means that the first sampling clock signal 215a in the first channel 509i is phase-shifted either through +90° or through −90° with respect to the second sampling clock signal 215b in the second channel 509q. The first sampling clock signal and the second sampling clock signal were derived from the difference frequency of the PLLs f_{IF1}, that is to say the IF reference signal 213 at the actual intermediate frequency f_{IF1} is used as the basis for the sampling clock signals 215a, 215b.

The clock signals, which have been phase-shifted through either +90° or −90° with respect to one another, in the clock channels 215a, 215b control the ADCs 502i, 502q with signals with a different phase angle, and in consequence generate signals 509i, 509q that are sampled at different times.

The first modulator 502i receives the first channel signal 504i from the splitting device 503, and, at its output, provides the first sampled digitized received signal 509i, or sampled first channel signal 509i.

The second modulator 502q provides the second sampled digitized received signal 509q or the second sampled channel signal 509q.

In a subsequent decimation filter 505 or decimation device 505, the sampled digitized received signals are low-pass-filtered 506i, 506q independently of one another, and are decimated 507i, 507q in the decimation device at the sampling rate.

The sampling devices or modulators 502i, 502q may be in the form of sigma-delta (ΣΔ) modulators. Furthermore, the sigma-delta modulators may also have an additional low-pass filter 506i, 506q.

A sigma-delta modulator may be in the form of a low-pass sigma-delta modulator (TP-ΣΔ). A TP-ΣΔ modulator may operate with a short word length but a high sampling clock rate, for example at the frequency of the sampling clock signal 215a, 215b. The word length may be 1 bit, a few bits or a plurality of bits. Because the word length is normally short, this may result in digitizing noise or quantization noise. Because of the high clock rate of the TP-ΣΔ modulators 502i, 502q, which corresponds essentially exactly to the carrier frequency f_{IF1} of the intermediate-frequency signal, and a suitable noise transfer function, the digitizing noise may be shifted into frequency ranges which can essentially be eliminated by means of the low-pass filter 506i, 506q. This shifting of the digitizing noise to a higher frequency range may be referred to as noise shaping. The noise shaping may essentially act only on the digitizing noise of the sampler in the TP-ΣΔ modulator 502i, 502q.

Since the phase noise contained in the received intermediate-frequency signal 206 is essentially unaffected by the low-pass filtering, the phase noise is essentially eliminated by the particular type of sampling in the samplers 502i, 502q. This particular type of sampling provides for the frequency of the sample signal 215a, 215b and the frequency of the intermediate-frequency signal 206 to be based essentially on the same frequency f_{IF1}.

The specific way of producing the reference signal f_{Ref1} proposed here, and the demodulation of the received signal 206 by means of the specific type of sampling in the TP-ΣΔ modulators 502i, 502q make it possible to prevent stabilization effects in the two PLLs PLL₁, PLL₂ affecting the phase angle of the received signal. Furthermore, the phase noise may be essentially suppressed. With regard to the specific way in which the reference signal is produced and the specific type of demodulation, care should be taken to ensure that signals which propagate on different paths in the UWB system contain the intermediate frequency. In other words, this means that the intermediate-frequency signal 206 as well as the sample signal 215a, 215b are derived from the same difference signal between the PLLs PLL₁ and PLL₂, as a result of which their phase noise is correlated. Both the received intermediate-frequency signal 206 and the sample signal 215a, 215b are at essentially the same carrier frequency, for example the intermediate frequency f_{IF1}. In consequence, these signals are correlated such that the stabilization effects and the phase noise do not have an excessive effect, since they act essentially in the same sense both on the intermediate-frequency signal 206 and on the clock signals 215a, 215b. The phase noise and the phase error in the two signals are mapped or correlated essentially in the same way, thus resulting in the phase noise and the phase error essentially being compensated for and suppressed during sampling.

The received intermediate-frequency signal 206 is essentially demodulated to baseband digitally in the digital signal preprocessing 207. At the two outputs 508i and 508q of the digital signal preprocessing 207, the UWB measurement system 500 produces the scatter parameter S11 as a function of the modulation frequency f_{Mod} or transmission frequency f_{Mod} to the downstream signal processing unit 216 (μC). In other words, the scatter parameter S11 which results when a specific modulation frequency f_{Mod} is applied is determined at the two outputs 508i and 508q. The signals at the outputs 508i, 508q of the decimation device 505, 507i, 507q are the clock-reduced first channel signal 508i and the clock-reduced second channel signal 508q. By way of example, these signals may be baseband signals.

The provision of the output signal in the two channels 508i and 508q or as separate signals 508i, 508q takes account of the fact that the scatter parameter S11 is a complex value. Splitting into an in-phase component (I) and a quadrature component (Q) means that the circuitry of a digital circuit can process even complex scatter parameters, that is to say scatter parameters with a real part and an imaginary part.

Splitting between two ADCs 502i, 502q makes it possible, particularly when using ΣΔ modulators, for the ADCs which are used not to be subject to stringent quality requirements, thus allowing the high-frequency IF signal 206 to be processed even with ADCs which can be implemented easily. The intermediate-frequency signal 206 or IF signal 206 may be a high-frequency signal.

The ADCs 502i and 502q are operated in a specific manner, for example by the control device 550 in order to provide complex sampling or demodulation. This specific type of sampling is described by the pulse combs 600 in FIG. 6. This type of sampling results in I/Q demodulation of the signal to be sampled. For example, this allows demodulation to be carried out to baseband.

The parallel signals 215a and 215b are illustrated on the normalized time axis 601 t*fₐ in FIG. 6. The time axis 601 is normalized using 1/Tₐ=fₐ. The time axis is therefore normalized with respect to the sampling period. Tₐ is the sampling period, and fₐ is the sampling frequency.

As can be seen from the scale 601 in FIG. 6, the second clock signal 215b or the Q-clock is shifted through −¼ of a clock cycle with respect to the first clock signal 215a or with respect to the I-clock, or has a phase shift of +90°. In the example in FIG. 6, the Q-clock 215b leads the I-clock 215a by ¼, n/2 or 90°. This specific form of operation or clocking of the sigma-delta modulators with a time offset of ±¼ of a clock cycle in each case allows complex sampling of the intermediate-frequency signal 206 whose carrier frequency is the intermediate frequency f_{IF1}.

Depending on whether the Q-channel 504q (shown at the bottom in FIG. 5) is sampled ¼ of a clock cycle before (plus 90 degrees) or ¼ of a clock cycle after (minus 90 degrees) the I-channel 504i, an appropriate image-frequency filter 801a, 801b may be chosen in the I-channel 504i.

The zero-order hold (ZOH) element 802 in the Q-channel 504q, 509q creates a transition to the zero-degree phase of the I-channel. In other words, the sampled digitized received signals 509i, 509q are synchronized by means of the zero-order hold element 802.

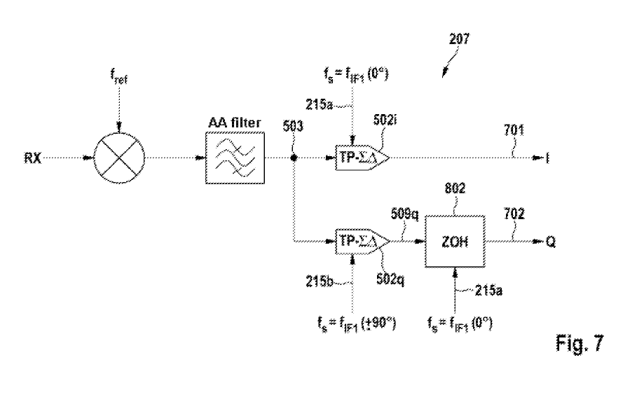

FIG. 7 shows a detail of a block diagram of one embodiment variant of the digital section 207 with reduced components, according to an exemplary embodiment of the present invention. In this simplified representation, the image-frequency filter 801a, 801b, 803, 802 and 806 is represented by a simplified embodiment, a single ZOH element 802. The detailed design of the image-frequency filter in the original form or according to another exemplary embodiment of the present invention is illustrated in the figure in FIG. 8.

The two ADCs 502i, 502q and the zero-order hold (ZOH) element 802 are provided in the digital stage 207. The first ADC 502i is operated 215a with the same clock as the zero-order hold element 802.

The second ADC 502q is operated with a sampling clock which leads or lags correspondingly by ±90 degrees, in order to achieve I/Q demodulation. Nevertheless, theoretically, simplified “image-frequency filtering” implicitly takes place in this case. The Q-channel 215b, which has been shifted through ±¼ of a clock cycle (±90°), is synchronized to the clock of the I-channel (0 degrees) 215a by means of the zero-order hold element 802.

An upgraded or improved image-frequency filter can also be provided in the circuit shown in FIG. 7, in order to increase the image-frequency suppression, and in particular further components 801a, 801b, 803, 806 may be added to the simple image-frequency filter 802. The two-stage decimation which is connected to the outputs 701, 702 is not illustrated in FIG. 7, but corresponds to the two-stage decimation which is described in FIG. 8.

FIG. 8 describes how an image-frequency filter 801a, 801b, 803, 806 such as this, which is additional to FIG. 7, or an upgraded image-frequency filter 801a, 801b, 803, 802, 806 can be used. FIG. 8 shows the two-stage decimation by means of a first decimation filter 804 and a second decimation filter 805. A two-stage decimation filter 804, 805 such as this is used in the circuit shown in FIG. 7, but is not shown in FIG. 7.

The image-frequency filter 801a, 801b, 803, 802, 806 shown in FIG. 8 can be implemented with little complexity, since it does not require any multiplications and uses only a small number of simple shift-add operations.

The ADCs 502i, 502q produce a first channel signal 509i, which is sampled at a high frequency, and a second channel signal 509q, which is sampled at a high frequency. The frequency or rate of these channel signals 509i, 509q which are sampled at a high frequency can be reduced by a downstream first decimation filter 804 and second decimation filter 805. After sampling, the channel signals which have been sampled at a high frequency and essentially correspond to a received signal without a carrier are in baseband. In consequence, the sampled channel signals are no longer at high frequency. For this reason, a clock reduction process can be carried out with the aid of the two decimation stages, taking account of the sampling theorem. In this case, the sampling theorem can be taken into account by setting the factor N such that the sampling rate of the output signals I, Q becomes as low as possible, that is to say N is chosen to be high but, in comparison to the useful signal bandwidth, not sufficiently high to satisfy the sampling theorem. Although N should be chosen to be high, N should not be chosen to be excessively high, in order to prevent aliasing.

The first decimation filter 804 described in FIG. 8 and the second decimation filter 805 can be implemented with little complexity and essentially without any multiplication stages by a small number of simple shift-add operations.

FIG. 8 shows a detailed illustration of the digital signal processing unit 207, which has a ΣΔ modulator 502i, 502q, a first clock reduction 507i, 507q, with the decimation factor OSR (Over Sampling Rate) and a second clock reduction device with the decimation factor N. The ΣΔ modulators 502i, 502q in conjunction with the decimation low-pass filter 804, 805 form a specific ΣΔ-AD converter (which is matched to the specific requirements of the radar system). The ADC (analog-digital converter or analog-to-digital converter) may therefore have a modulator 502i, 502q.

An appropriate image-frequency filter 801a, 801b in the in-phase channel 509i can be switched on by means of the switch 803 as a function of the phase angle chosen by means of the sample signal 215b.

When sampling with a lagging phase, a lagging phase of −90° is chosen for the quadrature sampling 215b, and the lagging image-frequency filter 801b is chosen. If a leading phase of +90° is chosen for the quadrature sampling 215b, then the leading image-frequency filter 801a is chosen by means of the switch 803.

The leading image-frequency filter 801a includes summation of a signal delayed by one clock cycle and of the current signal amplified three times. This corresponds to the filter coefficients B=[3, 1]. This notation is an abbreviation of the filter polygon notation y=(b₀+b₁ z⁻¹)x, where b₀=3 and b₁=1, that is to say y=3x+z⁻¹x.

The lagging image-frequency filter 801b includes an addition of the unamplified current signal and the signal which has been amplified three times and has been delayed by one clock cycle. This corresponds to the filter coefficients B=[1, 3], that is to say to the filter polygon y=x+3 z⁻¹x.

If the phase angle is predetermined and fixed, there is no need for the switch 803, and either a leading image-frequency filter or a lagging image-frequency filter can be provided permanently in the I-channel 509i.

The decimation of the decimation filter 505, 804, 805 is in the form of two-stage decimation with low-pass filtering. In other words, the decimation device 505 has the first decimation device 804 or first decimation stage 804 and the second decimation device 805 or second decimation stage 805. The sampling rate fₛ, fₐ, f_{if1} or f_{IF1}, in particular the sampled channel signal 509i, 509q with a corresponding clock rate, is reduced by the factors OSR and N in the first stage 804 and in the second stage 805. The last mixer stage M2 and the intermediate-frequency filter 204, which is used as an anti-aliasing (AA) filter, provide the intermediate-frequency signal at the frequency f_{IF1} 206 for the digital section 207.

OSR and N, that is to say the value of the clock reduction OSR and the value of the clock reduction N, are chosen such that the clocking of the output signals 508i, 508q while passing through the decimation device 505 is transferred from the intermediate frequency f_{IF1}=fₛ to a baseband signal 508i, 508q. The values OSR and N by which the clock reduction devices OSR and N respectively reduce the clock of the ΣΔ modulator output signals 509i, 509q or the channel signals 509i, 509q which are sampled at high frequency, are dependent on the configuration of the UWB system. The higher the frequency that is chosen for the sampling clock f_{IF1}=fₛ 215a, 215b, the higher the frequency that is chosen, or the higher the value of the clock reduction OSR or N may also be. The higher the frequency that is chosen for the sampling clock f_{IF1}=fₛ 215a, 215b, the more accurately it is also possible to form the low-pass-filtered and clock-reduced received signal 508i, 508q. In other words, the decimation device 505 may then have a higher signal-to-noise ratio (SNR) or a longer word length at the output.

The first decimation filter 804 represents a K₀-th order (K₀) decimation filter, and the second decimation filter 805 represents a K₁-th order (K₁) decimation filter. In this case, the value K₀ corresponds to the number of feedback elements 464a, and of the forward coupling elements 464b as shown in FIG. 4c, which are used in the first decimation stage 804.

The value K₁ in each case corresponds to the number of the feedback elements 464a and of the forward coupling elements 464b which are used in the second decimation stage 805, corresponding to the block diagram 462 (the second decimation stage 805 is not illustrated in FIG. 4c). The decimation factor N is used instead of the decimation factor OSR in the decimation element 465. FIR₂ is not included in the second decimation stage.

The complex sampling of the received intermediate-frequency signal 206, whose carrier frequency is f_{IF1}, is carried out by means of the two sigma-delta modulators 502i, 502q with a time offset of ±¼ of a clock cycle or a phase offset of ±90°, that is to say offset respectively by +¼ or −¼, or by +90° or −90°, with respect to the respective other channel. The intermediate-frequency signal 206 is copied into the two channels 504i and 504q in the splitting device 503.

Depending on whether the Q-channel 504q (at the bottom in FIG. 8) is sampled ¼ of a clock cycle before (plus 90 degrees) or after (minus 90 degrees) the I-channel 504i the appropriate image-frequency filter 801a, 801b is chosen in the I-channel 509i. The choice may be made, for example, by means of the selection device 803.

The lagging image-frequency filter 801b (chosen for) −90° has FIR (Finite Impulse Response) coefficients B=[1,3], while the leading image-frequency filter 801a (chosen for)+90° has the FIR coefficients B=[3,1]. In the Q-channel 505q, the zero-order hold (ZOH) element 802 produces a transition to the 0-degree phase of the I-channel, and synchronization of the two channels.

The sequence of decimation and low-pass filtering 804, 805 which follows the switch 803 and the quadruple amplification 806 is essentially identical for both channels I, Q.

The first decimation filter 804 is a sinc^{K0} (sine cardinal) decimation filter (FIR₁) 808i, 808q of order K₀ and with the decimation factor OSR, downstream from which an FIR filter (FIR₂) 809i, 809q with the coefficients B=[1, 2, 1] was additionally connected, after the sampling clock reduction 507i, 507q. The detailed design of the filters FIR₁ and FIR₂ is explained in FIG. 4c.

The second decimation filter 805 is likewise a sinc decimation filter which, however, has the order K₁ (sinc^{K1}) and the decimation factor N. An additional filter, which is comparable with FIR₂ 809i, 809q, is not provided in the second decimation stage 805.

In addition, signal components of the I-channel or Q-channel can be masked out in the second decimation stage by means of the hold input 807, via a hold signal. The hold signal is derived from PLL1 and/or PLL2 (not shown in FIG. 8) and is used to mask out the time interval in which the two PLL stages PLL1, PLL2 are stabilizing at their nominal value. In other words, the hold signal is adapted such that the hold signal 807 can mask out the I-channel signal and/or the Q-channel signal while at least one of the PLL stages PLL1, PLL2 is stabilizing at its nominal value. A stabilization process of the PLL stage may take place after the change to a frequency, for example when passing through the staircase ramp 300.

Therefore, a method and an apparatus are described for provision of a reflection signal, in which and intermediate-frequency signal which has a high carrier frequency f_{IF1} is sampled directly by means of the described complex sampling at the essentially actual exact intermediate frequency f_{IF1}, and can be demodulated into I/Q components in baseband. In the case of a baseband signal, the carrier is essentially eliminated. A complex reflection factor can thus be produced.

The method and the apparatus for provision of a reflection signal may demodulate an intermediate-frequency signal at a high intermediate frequency into I/Q components essentially without an intermediate frequency. A complex reflection factor can therefore be produced.

In addition, it should be noted that “comprising” and “having” do not preclude other elements or steps, and “a” or “one” does not preclude a multiplicity. Furthermore, it should be noted that features or steps which have been described with reference to one of the above exemplary embodiments can also be used in combination with other features or steps of other exemplary embodiments described above. Reference symbols in the claims should not be considered to be restrictive.

1. A method for provision of a reflection signal, comprising:
reception of an intermediate-frequency signal at an input of a splitting device, with the intermediate-frequency signal at an intermediate frequency;
reception of an intermediate-frequency reference signal at an input of a first sampling device, with the intermediate-frequency reference signal at the intermediate frequency;
reception of an intermediate-frequency reference signal at an input of a second sampling device, with the intermediate-frequency reference signal at the intermediate frequency;
splitting of the intermediate-frequency received signal into a first channel and a second channel;
provision of a first channel signal and of a second channel signal in the respective channel;
sampling of the first channel signal with a first clock signal derived from the intermediate-frequency reference signal;
sampling of the second channel signal with a second clock signal derived from the intermediate-frequency reference signal, with the second clock signal being shifted in phase with respect to the first clock signal;
synchronization of the sampled second channel signal with the clock of the first sampled first channel signal;
reduction in the clock of the sampled first channel signal and in the clock of the sampled second channel signal by means of a decimation device;
provision of the clock-reduced first channel signal; and
provision of the clock-reduced second channel signal.

2. The method as claimed in claim 1, wherein the intermediate-frequency reference signal is generated by mixing of a first output signal from a first signal generator and a second output signal from a second signal generator, as a result of which the intermediate-frequency reference signal is substantially at the exact intermediate frequency.

3. The method as claimed in claim 1, wherein the second clock signal is shifted in phase through either +90° or through −90° with respect to the first clock signal.

4. The method as claimed in claim 1, wherein the decimation device is formed from two stages.

5. The method as claimed in claim 4, wherein:
the first stage of the decimation device has a first-order decimation filter,
the first stage of the decimation device has a first decimation factor,
the second stage of the decimation device has a second-order decimation filter,
the second stage of the decimation device has a second decimation factor and
an additional filter is arranged between the first stage and the second stage.

6. The method as claimed in claim 1, wherein the second channel signal is synchronized to the first channel signal by means of a zero order hold element.

7. The method as claimed in claim 1, wherein the clock of the sampled second channel signal is synchronized to the clock of the sampled first channel signal by means of an image-frequency filter.

8. The method as claimed in claim 7, further comprising:
selection of the image-frequency filter as a function of the shift in the second clock signal with respect to the first clock signal.

9. The method as claimed in claim 1, wherein a sigma-delta modulator is used for sampling.

10. The method as claimed in claim 1, further comprising:
waiting for a stabilization time of a signal generator in a second stage of the decimation device;
decimation of the clock of the sampled first channel signal and/or of the sampled second channel signal in a signal propagation direction after image-frequency filtering in a first stage of the decimation device; and
decimation of the clock of the sampled first channel signal and/or of the sampled second channel signal in the second stage of the decimation device at a time after waiting for the stabilization time of the signal generator.

11. An apparatus for provision of a reflection signal, comprising:
a splitting device;
a first sampling device;
a second sampling device;
a synchronization device;
a first provision device;
a second provision device; and
a decimation device;
wherein the splitting device is designed for reception of an intermediate-frequency received signal at an input and for splitting the intermediate-frequency received signal into a first channel and a second channel, as a result of which the splitting device is designed for provision of a first channel signal and of a second channel signal in the respective channel,
wherein the first sampling device is designed for reception of an intermediate-frequency reference signal at an input of the first sampling device and for sampling of the first channel signal with a first clock signal derived from the intermediate-frequency reference signal,
wherein the second sampling device is designed for reception of the intermediate-frequency reference signal at an input of the second sampling device and for sampling of the second channel signal with a second clock signal derived from the intermediate-frequency reference signal,
wherein the second clock signal is shifted in phase with respect to the first clock signal,
wherein the synchronization device is designed for synchronization of the clock of the sampled second channel signal with the clock of the sampled first channel signal,
wherein the decimation device is designed for reduction of the clock of the sampled first channel signal and of the clock of the sampled second channel signal,
wherein the first provision device is designed for provision of the clock-reduced first channel signal, and
wherein the second provision device is designed for provision of the clock-reduced second channel signal.

12. The apparatus as claimed in claim 11, wherein the synchronization device is an image-frequency filter.

13. The apparatus as claimed in claim 11, wherein the synchronization device is designed for filtering of undesirable signal components.

14. The apparatus as claimed in claim 11, wherein the apparatus is in the form of an integrated circuit, an FPGA, an ASIC and/or a filter.

15. The apparatus as claimed in claim 11, wherein the apparatus is at least an appliance selected from the group of appliances consisting of:
a wall humidity measurement appliance,
a circular saw;
a jigsaw;
an angle grinder;
a lawnmower;
a hedge trimmer;
a shredder;
a fuel sensor;
an incorrect refueling sensor;
a material identification appliance; and
a lining detector.

16. The apparatus as claimed in claim 11, wherein the apparatus is designed as a multichannel measurement system.
